(19) United States
(12) Patent Application Publication
(10) Pub. No.: US 2014/0107983 A1
(43) Pub. Date: Apr. 17, 2014

(54) SYSTEMS AND METHODS OF DESIGNING NUCLEIC ACIDS THAT FORM PREDETERMINED SECONDARY STRUCTURE

(71) Applicant: California Institute of Technology, Pasadena, CA (US)

(72) Inventors: Brian R. Wolfe, Pasadena, CA (US); Niles A. Pierce, Pasadena, CA (US)

(73) Assignee: California Institute of Technology, Pasadena, CA (US)

(21) Appl. No.: 14/033,081

(22) Filed: Sep. 20, 2013

Related U.S. Application Data
(60) Provisional application No. 61/704,012, filed on Sep. 21, 2012.

(51) Int. Cl. G06F 19/12

(52) U.S. Cl. CPC G06F 19/12
USPC 703/1

(57) ABSTRACT

Described is a system and process for designing the equilibrium base-pairing properties of a test tube of interacting nucleic acid strands. A target test tube is specified as a set of desired ‘on-target’ complexes, each with a target secondary structure and target concentration, and a set of undesired ‘off-target’ complexes, each with vanishing target concentration. Sequence design is performed by optimizing the test tube ensemble defect, corresponding to the concentration of incorrectly paired nucleotides at equilibrium evaluated over the ensemble of the test tube.

### CROSS-REFERENCE TO RELATED APPLICATIONS

This application claim priority to U.S. Provisional Application Ser. No. 61/704,012 filed on Sep. 21, 2012, the entirety of which is hereby incorporated by reference.

### STATEMENT REGARDING FEDERALLY SPONSORED R&D

This invention was made with government support under CCF0832824 and CFF0448835 awarded by the National Science Foundation. The government has certain rights in the invention.

### BACKGROUND OF THE INVENTION

1. Field of the Invention

Embodiments of the invention relate to systems and methods for designing a nucleic acid molecule that will fold into a target secondary structure at a target concentration. More specifically, embodiments relate to methods and systems that allow the design of particular target secondary structures that will exist in a predefined environment, such as a dilute solution in a test tube.

2. Description of the Related Art

The programmable chemistry of nucleic acid base pairing serves as a versatile medium for the rational design of self-assembling molecular structures, devices, and systems. To date, considerable effort has been invested in designing the equilibrium base pairing properties of a single complex of (one or more) interacting nucleic acid strands. However in these earlier efforts, neither the concentration of the complex, nor the concentrations of other undesired complexes were considered. As a result, sequences that were successfully optimized to stabilize a target secondary structure in the context of a complex, may nonetheless fail to ensure that the target complex would actually form at appreciable concentration when the strands were introduced into a test tube in the lab (see FIG. 1).

We have previously shown that the design of target nucleic acid structures can be formulated as an optimization problem based on a physically meaningful objective function, the complex ensemble defect (Zadeh, et al. (2011) NUPACK: Analysis and design of nucleic acid systems J. Comput. Chem. 32, 170-173 and Zadeh, et al. (2011) Nucleic acid sequence design via efficient ensemble defect optimization. J. Comput. Chem. 32, 439-452). In this work, a candidate sequence and target secondary structure were evaluated as a complex ensemble defect corresponding to the average number of incorrectly paired nucleotides at equilibrium evaluated over the ensemble of the complex.

### BRIEF DESCRIPTION OF THE DRAWINGS

FIGS. 1a and 1b show a schematic comparison of prior art complex design (FIG. 1a) with an embodiment of a test tube design (FIG. 1b).

FIG. 2 is a schematic that shows one embodiment of a hierarchical decomposition process of an on-target structure.

FIG. 3-Efficient estimation of physical quantities from nodal contributions. (a) Complex partition function estimate. Conceptually, Qₖ_{ₗ}^{native} the native partition function of child kₗ (calculated on child node kₗ at cost Θ(|φₖ_{ᵢ}|³), approximates the contribution of the left-child nucleotides to the partition function of parent k (which can be calculated exactly on parent node k at higher cost Θ(|φₖ|³)). (b) Complex ensemble defect estimate. Conceptually, nₖ_{ₗ}^{native} the native defect of child kₗ (calculated on child node kₗ at cost Θ(|φₖ_{ₗ}|³), approximates the contribution of the left-child nucleotides to the native defect of parent k (which can be calculated exactly on parent node k at higher cost Θ(|φₖ|³)).

FIGS. 4a-d are line graphs that show structural features of tetramer target structures for the on-target complexes in a standard test set. FIG. 4a shows the fraction of bases paired. FIG. 4b shows the number of duplex stems per structure. FIG. 4c shows the number base pairs per stem. FIG. 4d shows the minimum number of base pairs that must be cut to disconnect a strand from a structure.

FIGS. 5a-e show line graphs that compare embodiments of the present invention to prior complex design processes. Embodiments of the test tube design process described below are shown as solid lines and the prior single-complex design process is shown as dashed lines for the design of test tubes containing only a single on-target complex. FIG. 5a shows the normalized ensemble defect which infers design quality. The stop condition is depicted as a dashed line. FIG. 5b shows design cost. FIG. 5c shows sequence composition. The initial GC content is depicted as a dashed line. FIG. 5d shows the cost of sequence design relative to a single evaluation of the objective function. The optimality bound is depicted as a dashed line. FIG. 5e shows leaf independence and emergent defects. A comparison of the complex ensemble defect to the leaf-based estimate of the complex ensemble defect at three stages in the sequence design process: random initial sequence, after initial leaf optimization, after the completion of complex design. Dots represent design trials. Symbols denote medians for each size of on-target structure in the standard test set (|s|={100, 200, 400, 800}; symbol size increases with |s|. RNA design was performed at 37° C. The test set shown is a single-complex version of the standard test set with all the off-targets removed from the test tubes.

FIG. 6 is a line graph showing the design quality of a set of sequences. Comparison of the test tube ensemble defect achieved for test tube design (solid line; design for the on-targets and against the off-targets) vs the prior complex design (dashed line; design for the on-targets while ignoring the off-targets). The stop condition is depicted as a dashed line. RNA design was performed at 37° C. for the standard test set.

FIGS. 7a-e show the process performance for test tube design. FIG. 7a shows design quality with the stop condition depicted as a dashed line. FIG. 7b shows the design cost. FIG. 7c shows the sequence composition with the initial GC content depicted as a dashed line. FIG. 7d shows the cost of sequence design relative to a single evaluation of the objective function. FIG. 7e shows leaf independence and emergent defects. A comparison of the test tube ensemble defect to the leaf-based estimate of the test tube ensemble defect at four stages in the sequence design process: random initial sequence, after initial leaf optimization (for on-target complexes), after initial forest optimization (for on-target complexes), after the completion of test tube design (including destabilization of any troublesome off-target complexes). Dots represent design trials. Symbols denote medians for each size of on-target structure in the standard test set (|s|={100, 200, 400, 800}; symbol size increases with |s|. RNA design at 37° C. for the standard test set.

FIGS. 8a and 8b show parallel process performance FIG. 8a shows parallel efficiency and FIG. 8b shows parallel speedup using multiple computational cores. Using M computational cores, efficiency (|s|,M)=t(|s|,1)/(t(|s|,M)×M) and speedup (|s|,M)=t(|s|,1)/t(|s|,M), where t is wall clock time. Dashed lines denote boundaries between compute nodes, indicating the use of message passing. RNA design at 37° C. on the standard test set.

FIGS. 9a-d are line graphs that show the effect on process performance of GC content used for seeding and reseeding with embodiments of the invention. RNA design was performed at 37° C. on the standard test set.

FIGS. 10 a-d show the effect of design material on process performance RNA design was performed at 37° C. and DNA design was performed at 25° C.

FIGS. 11a-e show test tube design with multiple on- and off-target complexes. In this design, target test tubes contained four tetramer on-targets and all off-target complexes up to size Lₘₐₓε{0,1,2,3,4}. FIG. 11a shows design quality: test tube ensemble defect for a test tube containing all complexes of up to size Lₘₐₓ=4. The stop condition depicted as a dashed line (Lₛₜₒₚ=0.02). FIG. 11b shows the design cost. FIG. 11c shows a sequence composition. The initial GC content is depicted as a dashed line. FIG. 11 d shows the cost of sequence design relative to a single evaluation of the test tube ensemble defect for a test tube containing all complexes of up to size Lₘₐₓ=4. FIG. 11e shows the relative design cost. RNA sequence design was performed at 37° C.

FIGS. 12a-g show a target test tube and graphs for designing competing on-target complexes. FIG. 12a is a schematic showing that monomer and dimer on-targets compete for the same strand. To examine the challenge of designing the monomer and dimer on-targets with different relative stabilities, a range of target test tubes were defined by sweeping the target concentration of the monomer, yₘₒₙₒₘₑᵣ, from 0 to 1 μM in 0.01 μM increments, while letting y_{dimer}=(1−yₘₒₙₒₘₑᵣ)/2, so that the total strand concentration is fixed at 1 μM. b,c) Sequence designs with complementarity constraints (intended complements required to be Watson-Crick pairs). In FIGS. 12d and 12e, sequence designs without complementarity constraints (intended complements permitted to be Watson-Crick pairs, wobble pairs, or mismatches) are shown. In FIGS. 12f and 12g, the robustness of design quality predictions to model perturbations for sequence designs without complementarity constraints are shown. Each design trial evaluated with 100 perturbed models with every parameter perturbed by Gaussian noise with a standard deviation of 10% of the parameter modulus. FIGS. 12b, 12f and 12d show the median design quality for each target test tube. FIGS. 12c, 12e and 12g show the cumulative histogram of design quality for selected target test tubes with yₘₒₙₒₘₑᵣε{0,0.33,0.67,1.0} μM. RNA sequence design was performed at 37° C. with 100 design trials for each target test tube. The test tube stop condition is depicted as a dashed line (fₛₜₒₚ=0.02).

FIG. 13 is a line graph that shows the robustness of design quality predictions to model perturbations. Each sequence design was evaluated using 100 perturbed physical models, with each parameter perturbed by Gaussian noise with a standard deviation of 5, 10, 20, or 40 percent of the parameter modulus. RNA design was performed at 37° C. for target test tubes in the standard test set with |s|=200.

### SUMMARY

One embodiment is a method of designing the sequence of nucleic acid molecules that will form a predetermined secondary structure in solution. This method includes providing a set of desired on-target nucleic acid complexes each having a target secondary structure and a target concentration; providing a set of undesired off-target nucleic acid complexes each having a vanishing target concentration; and designing the sequence of one or more nucleic acid molecules that will predominantly form the on-target secondary structures at approximately the on-target concentrations, and will predominantly not form the undesired off-target complexes.

Another embodiment is an electronic system configured to design a sequence of nucleic acid molecules that will form a predetermined secondary structure in solution. This embodiment can include a first module configured to determine a set of desired on-target nucleic acid complexes each having a target secondary structure and a target concentration; a second module configured to determine a set of undesired off-target nucleic acid complexes each having a vanishing target concentration; a processor programmed to design the sequence of one or more nucleic acid molecules that will predominantly form the on-target secondary structures at approximately the on-target concentrations, and will predominantly not form the undesired off-target complexes; and an output port configured to output the design of the one or more nucleic acid molecules.

Yet another embodiment is a non-transitory computer readable medium comprising instructions that when executed by a processor perform a method of: providing a set of desired on-target nucleic acid complexes each having a target secondary structure and a target concentration; providing a set of undesired off-target nucleic acid complexes each having a vanishing target concentration; and designing the sequence of one or more nucleic acid molecules that will predominantly form the on-target secondary structures at approximately the on-target concentrations, and will predominantly not form the undesired off-target complexes.

### DETAILED DESCRIPTION

Embodiments of the invention relate to methods and electronic systems for designing a target secondary structure of a nucleic acid molecule that will form as a predominant species under predetermined environmental conditions. For example, in one embodiment the system can design a target secondary structure of a nucleic acid molecule at a target concentration in a dilute solution. In this case, the salt concentration, and/or temperature of the dilute solution would be one predetermined condition. Using the methods, systems and modules described herein, one can calculate the equilibrium base-pairing properties of a dilute solution of interacting nucleic acid strands (e.g., a “test tube”), yielding predictions for the equilibrium concentration and base-pairing probabilities for an arbitrary number of complex species that form from an arbitrary number of strand species.

As used herein a dilute solution means a solution in which the concentration of solvent molecules is much higher than the concentration of nucleic acid strands. For example, dilute solutions may have a concentration of 10 mM, 1 mM, 100 μM, 10 μM, 1 μM, 1 nM, 1 pM, 1 fM, 1 aM, 1 zM, or 1 yM and be within the scope contemplated by embodiments of the invention.

Accordingly, embodiments of the invention include programmed modules that have been configured to formulate the design of nucleic acid sequences in the context of a test tube of interacting nucleic acid strands at equilibrium. As used herein this type of design contemplates not only the base-pairing properties of a candidate nucleic acid strand, but also the predetermined environmental conditions that the nucleic acid will be placed into, and is termed herein “test tube design”. This allows the system to design nucleic acid sequences that interact at equilibrium to form a target secondary structure at a target concentration for an arbitrary number of desired complexes (the “on-target” complexes). The system also designs against formation of an arbitrary number of undesired complexes, each specified with a vanishing target concentration such as zero (the “off-target” complexes).

In one embodiment, a “test tube ensemble defect” is calculated, which represents the concentration of incorrectly paired nucleotides at equilibrium evaluated over the ensemble of the test tube. By calculating a test tube ensemble defect, the system is able to not just consider whether a target secondary structure has formed, but also take into consideration, and minimize, the formation of other off-target complexes of monomers, dimers, etc. that would form at the same time. This allows the system to determine a nucleic acid that not only forms into a target secondary structure, but also would form that structure as a dominant species in solution.

In one embodiment, the test tube ensemble defect is estimated by decomposing the target structure for each on-target complex into a tree of substructures, as described below. This leads to a forest of decomposition trees, with one tree for each on-target complex. The test tube ensemble defect at the root level of the forest can be efficiently estimated using only physical quantities calculated inexpensively at the leaf nodes of the forest, or at any other level of the forest intermediate between the leaf and root levels.

One embodiment is an electronic system that is configured to design a sequence of nucleic acid molecules, such as RNA molecules, that will form a predetermined secondary structure in solution. This electronic system can comprise several functional modules programmed to carry out aspects of the invention. The modules may be software modules stored in the memory of a computer system or a combination of software and processor executing instructions provided by the software to carry out aspects of the invention. Accordingly, the system may include a first module configured to determine a set of desired on-target nucleic acid complexes each having a target secondary structure and a target concentration. The system may also have a second module configured to determine a set of undesired off-target nucleic acid complexes each having a vanishing target concentration. Finally, the system may include at least one processor programmed to design the sequence of one or more nucleic acid molecules that will predominantly form the on-target secondary structures at approximately the on-target concentrations, and will predominantly not form the undesired off-target complexes. In order to provide an output of the designed nucleic acid molecules, the system may have an output port configured to output the design of the one or more nucleic acid molecules. In this circumstance, the output port may be connected to a computer or mobile display screen for displaying the sequence of the designed nucleic acid molecule, or a printer configured to print a copy of the designed nucleic acid molecule. Other possible output formats known to those with ordinary skill in the art are also contemplated within aspects of the invention.

The one or more processors in the system may also be programmed to calculate a test tube ensemble defect corresponding to the concentration of incorrectly paired nucleotides in a candidate sequence at equilibrium evaluated over the ensemble of a theoretical test tube containing the nucleic acid molecules, by the methods described herein and the pseudocode provided in the Appendix.

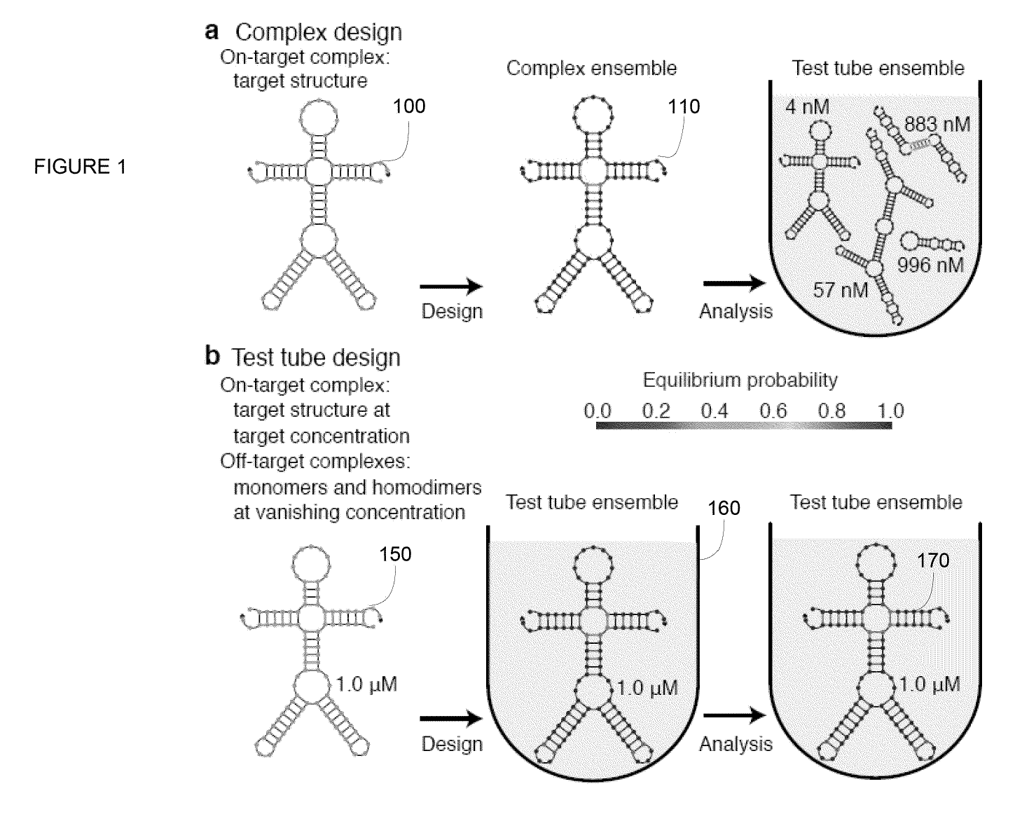

FIG. 1a, shows a schematic example of the prior art “complex design” method of determining a nucleic acid molecule that will form a target secondary structure 100. Sequence design formulated in the context of the target complex 100 ensures that at equilibrium the calculated target structure 110 dominates the structural ensemble of the complex that is determined by the complex design process. Unfortunately, subsequent thermodynamic analysis of the calculated target molecule in the context of a test tube can reveal that the desired target complex 100 occurs at negligible concentration (4 nm) relative to other undesired monomers and homodimers when actually built and put into solution in a test tube. FIG. 1b illustrates one embodiment of the result if the “test tube design” process described herein, wherein the target sequence structure 150 is formulated in the context of a test tube 160 which ensures that at equilibrium an actual molecule 170 having the calculated nucleotide sequence of the desired ‘on-target’ complex be the dominate target structure and form at approximately its target concentration. Moreover, with test tube design, the undesired ‘off-target’ complexes (all monomers and homodimers) will form at negligible concentrations. This allows any subsequent thermodynamic analysis in the context of a test tube (right) to be consistent with the test tube design formulation.

In one embodiment of a test tube design system, as described herein, the user specifies: 1) a set of desired on-target complexes, each with a target secondary structure and target concentration, 2) a set of undesired off-target complexes, each with vanishing target concentration. Given these parameters, the modules within the system derive a “test tube ensemble defect”, corresponding to the concentration of incorrectly paired nucleotides at equilibrium evaluated over the ensemble of the test tube. To efficiently optimize the test tube ensemble defect, the system builds on hierarchical sequence optimization concepts previously developed by us for complex design (See U.S. Pat. No. 8,478,543 entitled “System and Method for Nucleic Acid Sequence Design”, hereby incorporated by reference in its entirety). However, embodiments of the current invention address new conceptual challenges that arise in the context of test tube design which better reflects real-world experimental conditions, in that undesired off-target complexes compete with the desired on-target complexes.

In one embodiment, the process of determining the sequence of a nucleic acid that will form a target structure at a target concentration in predetermined environmental conditions begins by describing the physical quantities that provide the basis for analyzing and designing the equilibrium base-pairing properties of a test tube of interacting nucleic acid strands. This description starts with defining a secondary structure model for the nucleic acid strands to be evaluated.

### Secondary Structure Model

The sequence, φ, of one or more interacting RNA strands is specified as a list of bases φ^{a}ε{A, C, G, U} for a=1, . . . , |φ| (T replaces U for DNA). A secondary structure, s, of one or more interacting RNA strands is defined by a set of base pairs (each a Watson-Crick pair [A•U or C•G] or a wobble pair [G•U]). A polymer graph representation of a secondary structure is constructed by ordering the strands around a circle, drawing the backbones in succession from 5′ to 3′ around the circumference with a nick between each strand, and drawing straight lines connecting paired bases. A secondary structure is unpseudoknotted if there exists a strand ordering for which the polymer graph has no crossing lines. A secondary structure is connected if no subset of the strands is free of the others. A complex of interacting strands with strand ordering, π, has structural ensemble, Γ(π), containing all connected polymer graphs with no crossing lines. For sequence φ and secondary structure, sεF, the free energy, ΔG(φ, s), is calculated using nearest-neighbor empirical parameters for RNA in 1M Na⁺ or for DNA in user-specified Na⁺ and Mg⁺⁺ concentrations. These physical models have practical utility for the analysis and design of functional nucleic acid systems, and provide the basis for rational analysis and design of equilibrium base-pairing in the context of a dilute solution.

Now that a model has been formulated to analyze the secondary structure of interacting nucleic acid molecules, the system also provides a means for determining the equilibrium base pairing of nucleotides within the interacting nucleic acid molecules.

### Analyzing Equilibrium Base-Pairing in a Test Tube

Let Ψ⁰ denote the set of strand species that interact in a test tube to form the set of complex species Ψ. For complex jεΨ, with sequence φⱼ and structural ensemble Γⱼ, the partition function

$$Q ( {φ}_{j} ) = {\sum }_{s ∈ {Γ}_{j}}^{ } exp ⌊ - Δ G ( {φ}_{j} , s ) / {k}_{B} T ⌋$$

can be used to calculate the equilibrium probability of any secondary structure sεΓⱼ:

p(φⱼ,s)=exp└−ΔG(φⱼ,s)/k_{B}T┘/Q(φⱼ).

Here, k_{B} is the Boltzmann constant and T is temperature. The equilibrium base-pairing properties of complex j are characterized by the base-pairing probability matrix P(φⱼ), with entries P^{a,b}(φⱼ)ε[0, 1] corresponding to the probability,

$${P}^{a , b} ( {φ}_{j} ) = {\sum }_{s ∈ {Γ}_{j}}^{ } p ( {φ}_{j} , s ) {S}^{a , b} ( s ) ,$$

that base pair a·b forms at equilibrium within ensemble Γⱼ. Here, S(s) is a structure matrix with entries S^{a,b}(s)=1 if structure s contains base pair a·b and S^{a,b}(s)=0 otherwise. For convenience, the structure and probability matrices are augmented with an extra column to describe unpaired bases. The entry S^{a,|s|+1}(s) is unity if base a is unpaired in structure s and zero otherwise; the entry P^{a,|φ}^{ⱼ}^{|+1}(φⱼ)ε[0,1] denotes the equilibrium probability that base a is unpaired over ensemble Γⱼ. Hence the row sums of the augmented S(s) and P(φ) matrices are unity.

Let Q_{Ψ}=Qⱼ∀jεΨ denote the set of partition functions for the complexes in the test tube. The set of equilibrium concentrations, x_{Ψ}, (specified as mole fractions) are the unique solution to the strictly convex optimization problem:

$$\begin{matrix}{min}_{{x}_{ψ}} {\sum }_{j ∈ ψ}^{ } {x}_{j} ( log {x}_{j} - log {Q}_{j} - 1 ) \\ subject to & ( 1 a ) \\ {A}_{i , j} {x}_{j} = {x}_{i}^{0} ∀ i ∈ {ψ}^{0} , & ( 1 b )\end{matrix}$$

where the constraints impose conservation of mass. A is the stoichiometry matrix with entries A_{i,j} corresponding to the number of strands of type i in complex j, and xᵢ⁰ is the total concentration of strand i introduced to the test tube.

To analyze the equilibrium base-pairing properties of a test tube of nucleic acid strands, the partition function, Q(φⱼ), and equilibrium pair probability matrix, P(φⱼ), are calculated for each complex jεΨ using θ(|φⱼ|³) dynamic program modules. The equilibrium concentrations, x_{Ψ}, are calculated by solving the convex programming problem (equation (1)) using an efficient trust region method at a cost that is typically negligible by comparison. The overall time complexity to analyze the test tube is then O(|Ψ∥φ|³ₘₐₓ), where |φ|ₘₐₓ is the size of the largest complex.

In specifying an analysis problem, a convenient and powerful approach is to define Ψ if to include all complexes of up to Lₘₐₓ strands. For a test tube containing the set of strands, Ψ⁰, the total number of complexes that can form of up to size Lₘₐₓ is:

$$\vert ψ \vert = {\sum }_{L = 1}^{{L}_{max}} {\sum }_{l = 1}^{L} \frac{{\vert {ψ}^{0} \vert}^{gcd ( l , L )}}{L} , \qquad ( 2 )$$

so the overall time complexity to analyze the test tube is O(|Ψ⁰|^{L}ₘₐₓ|s|³ₘₐₓ/Lₘₐₓ).

### Test Tube Design Problem Specification

A test tube design problem is specified as a target test tube containing a set of desired on-target complexes, Ψₒₙ, and a set of undesired off-target complexes, Ψ_{off}. The set of complexes in the test tube is then:

ψ=ψₒₙ∪ψ_{off}.

Each complex, jεΨ, is specified as a strand ordering, πⱼ, corresponding to structural ensemble Γ(πⱼ). For each on-target complex, jεΨₒₙ, the user specifies a target secondary structure, sⱼ, and a target concentration, yⱼ. For each off-target complex, jεΨ_{off}, the target concentration is vanishing (yⱼ=0) and there is no target structure (sⱼ=Ø). When specifying the off-targets in Ψ_{off}, it is convenient to include all complexes of up to Lₘₐₓ strands. For example, by equation 2, four strands can interact to form 108 complexes of up to size four.

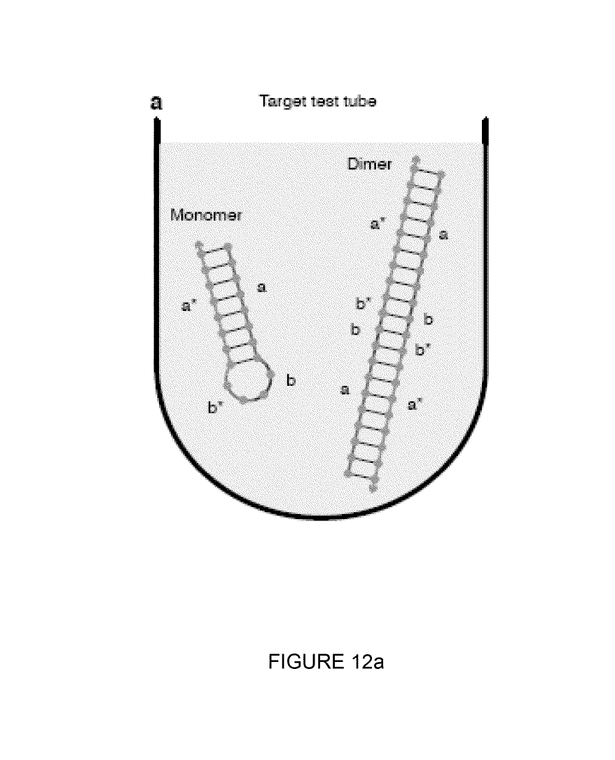

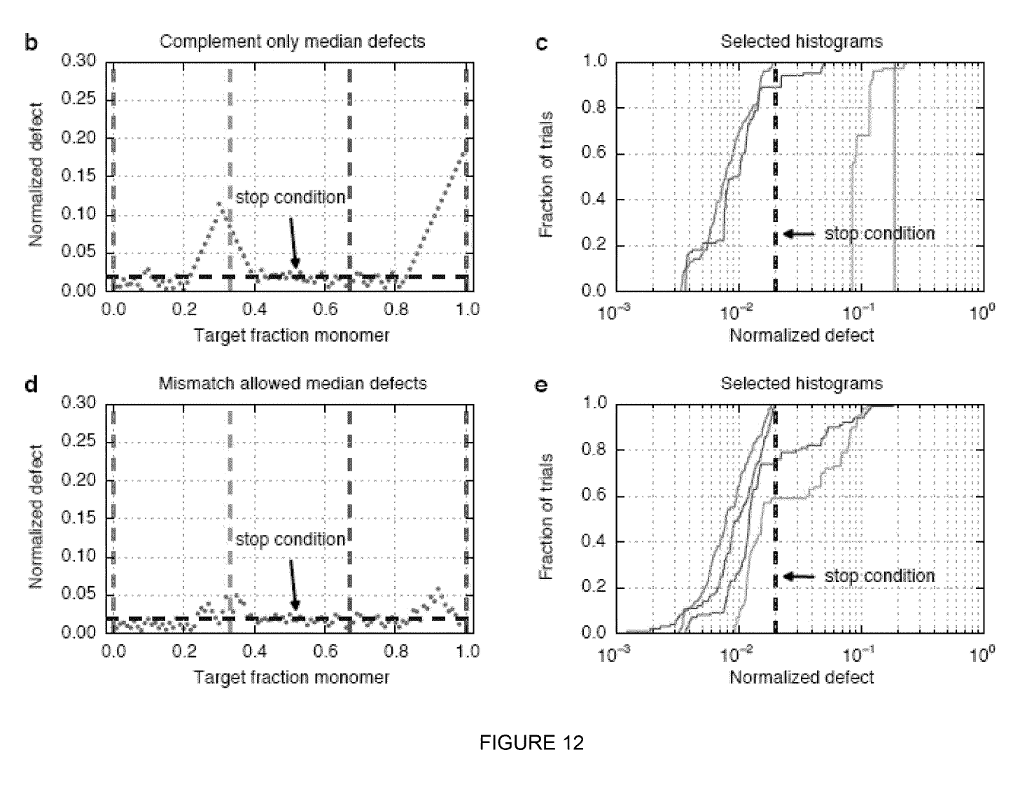

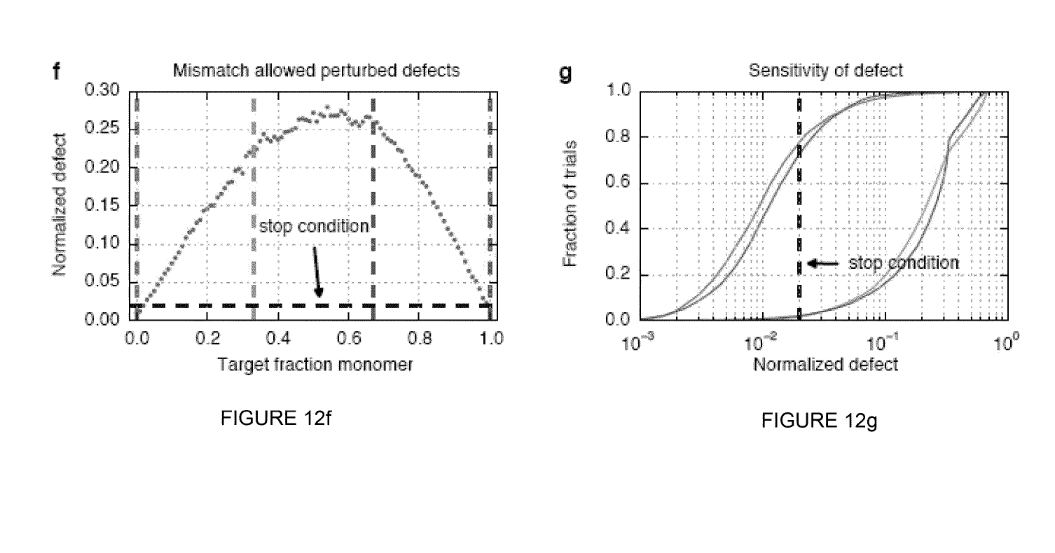

Complementarity constraints may be imposed on the design at the sequence level by defining strands in terms of sequence domains (e.g., see the sequence domains in the monomer and dimer on-target structures of FIG. 12a) and at the structural level by specifying base-pairing within the on-target structures. Complementarity constraints can propagate between complexes if, for example, nucleotides a and b are paired in one on-target structure and nucleotides b and c are paired in another on-target structure.

### Test Tube Ensemble Defect Objective Function

Described herein are methods, systems and modules configured to perform sequence optimization for a test tube design based on a physically meaningful objective function that quantifies sequence quality with respect to the environment of a target test tube. This allows the design of nucleic acid sequences that will form a target secondary structure in a chosen concentration when tested in vitro in solution.

As a precedent for this approach, consider the related problem of complex design, where the goal is to design strands that, at equilibrium, adopt a target secondary structure within the ensemble of a complex, without considering the environment (e.g., a dilute solution) that the nucleic acid will eventually be placed within. For a candidate sequence, φⱼ, and target structure, sⱼ, the complex ensemble defect

$$n ( {φ}_{j} , {s}_{j} ) = \vert {s}_{j} \vert - {\sum }_{{{1 \leq a \leq \vert {φ}_{j} \vert}_{1 \leq b \leq \vert {φ}_{j} \vert + 1}}_{ }} {P}^{a , b} ( {φ}_{j} ) S ( {s}_{j} ) , \qquad ( 3 )$$

is the average number of incorrectly paired nucleotides at equilibrium evaluated over the ensemble of the complex, Γⱼ. The complex ensemble defect falls in the interval (0,|sⱼ|). For complex design, the complex ensemble defect provides a physically meaningful objective function for quantifying sequence quality.

Here, to provide a basis for evaluating candidate nucleic acid sequences in the context of a test tube, we derive the “test tube ensemble defect”, representing the concentration of incorrectly paired nucleotides at equilibrium evaluated over the ensemble of the test tube. For a target test tube with target secondary structures, s_{Ψ}, target concentrations, y_{Ψ}, and candidate sequences, φ_{Ψ}, the test tube ensemble defect

$$C ( {φ}_{Ψ} , {s}_{Ψ} , {y}_{Ψ} ) = {\sum }_{j ∈ Ψ}^{ } c ( {φ}_{j} , {s}_{j} , {y}_{j} ) \qquad ( 4 )$$

may be expressed in terms of the defect contribution of each complex jεΨ:

$$c ( {φ}_{j} , {s}_{j} , {y}_{j} ) = n ( {φ}_{j} , {s}_{j} ) min ( {x}_{j} , {y}_{j} ) + \vert {s}_{j} \vert max ( {y}_{j} - {x}_{j} , 0 ) . \qquad ( 5 )$$

For each on-target complex jεΨₒₙ, the first term in equation (5) represents the structural defect, quantifying the concentration of nucleotides that are in an incorrect base-pairing state on average within the ensemble of complex j, and the second term represents the concentration defect, quantifying the concentration of nucleotides that are in an incorrect base-pairing state because there is a deficiency in the concentration of complex j. Because yⱼ=0 for off-target complexes, the structural and concentration defects are both identically zero (so the sum in equation (4) may be written over Ψₒₙ instead of ‘Ψ’). This does not mean that the defects associated with the off-targets are ignored. By conservation of mass, non-zero off-target concentrations imply deficiencies in on-target concentrations, and these concentration defects are quantified by equation (4).

The test tube ensemble defect falls in the interval (0,yₙₜ), where

$${y}_{nt} ≡ {\sum }_{j ∈ {Ψ}_{on}}^{ } \vert {s}_{j} \vert {y}_{j}$$

is the total concentration of nucleotides in the test tube.

Note that if there is only one species of complex in the test tube (|Ψ|=1), its concentration is necessarily equal to the target concentration (x₁=y₁), so the formulation is independent of concentration. In this case, optimization of the test tube ensemble defect, C(φ₁,s₁,y₁), is equivalent to optimization of the complex ensemble defect, n(φ₁,s₁).

Calculation of the test tube ensemble defect (equation 4) requires calculation of the complex partition functions, Q_{Ψ}, which are used to calculate the equilibrium concentrations, x_{Ψ}, as well as the equilibrium pair probability matrices, P_{Ψ}_{ₒₙ}, which are used to calculate the complex ensemble defects, n_{Ψ}_{ₒₙ}. Hence, the time complexity to evaluate the test tube ensemble defect is the same as the time complexity to analyze equilibrium base-pairing in a test tube.

### Overview of the Process

With the above structure in place, below is a description of a “test tube” design system and process that includes modules for calculating the nucleic acid sequence of a nucleotide strand that will adopt a target secondary structure at a target concentration in solution based on test tube ensemble defect optimization. For a target test tube with target secondary structures, s_{Ψ}, and target concentrations, y_{Ψ}, the system seeks to design a set of sequences, φ_{Ψ}, such that the test tube ensemble defect satisfies the test tube stop condition:

C(φ_{Ψ},s_{Ψ},y_{Ψ})≦Cₛₜₒₚ (6)

with

Cₛₜₒₚ≡fₛₜₒₚyₙₜ (7)

for a user-specified value of fₛₜₒₚε(0,1). It should be realized that the fₛₜₒₚ condition may be, for example, between 0.5 and 0.001 in some embodiments. For example, the fₛₜₒₚ condition may be 0.5, 0.2, 0.1, 0.05, 0.02, 0.01, 0.005, or 0.001. Using this notation, an fₛₜₒₚ of 0.01 would correspond to requiring a normalized test tube ensemble defect of greater than 1%.

The test tube ensemble defect is reduced via iterative mutation of a random initial sequence. Because of the high computational cost of calculating the test tube ensemble defect, the system tries to avoid direct recalculation of C in evaluating each candidate mutation. To reduce the cost of sequence optimization, each on-target structure is decomposed into a tree of substructures, yielding a “forest” of decomposition trees. Candidate mutations are evaluated efficiently by estimating the test tube ensemble defect based on nodal contributions calculated efficiently at the leaves of the decomposition forest.

During leaf optimization, defect-weighted mutation sampling is used to select each candidate mutation position with probability proportional to its contribution to the estimated test tube ensemble defect. As optimized subsequences are merged toward the root level of the forest, emergent defects that arise due to crosstalk between subsequences are eliminated via reoptimization within a defective subtree. After subsequences are merged to the root level, the full test tube ensemble defect, C, is calculated for the first time, including all on- and off-target complexes in the test tube ensemble. Any off-target complexes that form at appreciable concentration are decomposed, added to the decomposition forest, and actively destabilized during subsequent forest reoptimization. The exclusion of off-targets from the decomposition forest during the initial phase of sequence design is critical to enabling the design of test tubes containing large numbers of off-target complexes (e.g., 10⁴ off-targets). The elements of this hierarchical sequence design process are described below and detailed in the pseudocode in the attached appendix.

### Initialization

To initialize the system, a set of nucleic acid molecule complexes, Ψ, is partitioned into two disjoint sets of complexes:

Ψ=Ψ_{active}∪Ψₚₐₛₛᵢᵥₑ

where Ψ_{active} denotes complexes that will be actively designed and Ψₚₐₛₛᵢᵥₑ denotes complexes that will inherit sequence information from Ψ_{active}. Initially, we set

Ψ_{active}=Ψₒₙ,Ψₚₐₛₛᵢᵥₑ=Ψ_{off}

so that only the on-target complexes are actively designed. The user-specified on-target structures provide the basis for hierarchical structure decomposition, which enables efficient sequence design. The sequences for the complexes jεΨ_{active} are randomly initialized subject to respecting complementarity constraints provided by the design problem specification. Watson-Crick complements are used to initialize complementary sequence domains or any bases that are paired within an on-target structure.

### Hierarchical Decomposition of On-Target Structures.

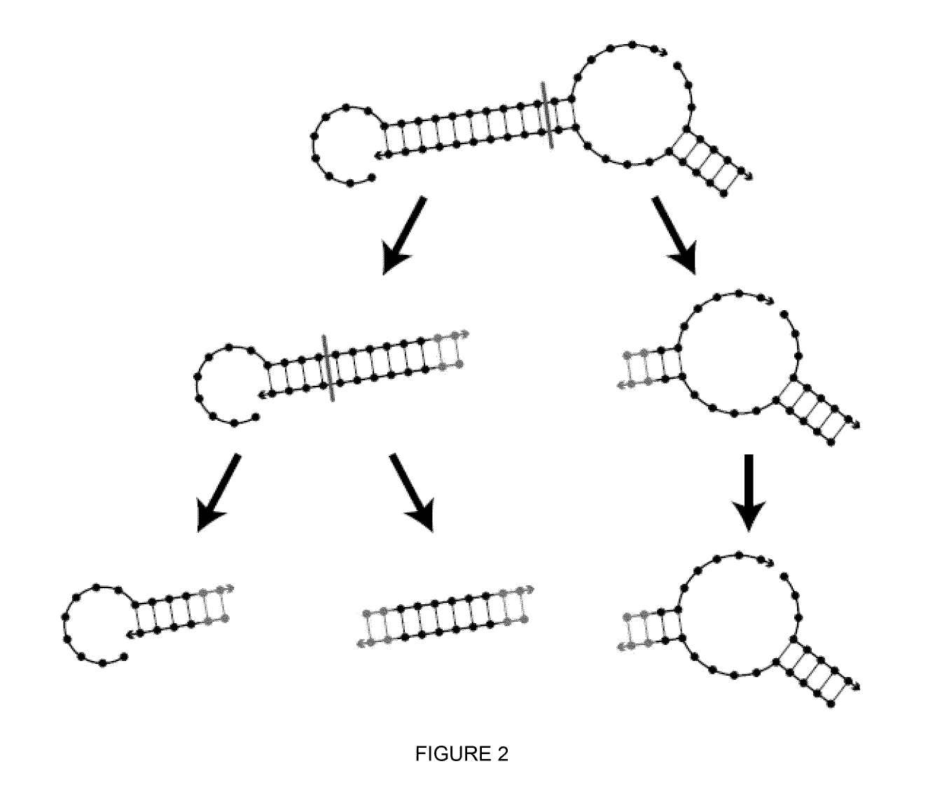

The hierarchical decomposition module is configured to decompose each on-target structure into a binary tree of substructures. Each target structure sⱼεΨ_{active} is decomposed into a (possibly unbalanced) binary tree of substructures, resulting in a forest of |Ψₒₙ| trees. Each node in the forest is indexed by a unique integer k. For each parent node, k, there is a left child node, kₗ, and a right child node, kᵣ. Each nucleotide in parent structure sₖ is partitioned to either the left or right child substructure (sₖ=sₖ^{l}∪sₖ^{r}, sₖ^{l}∩sₖ^{r}=Ø). Eligible split-points are those locations within a duplex stem with at least Hₛₚₗᵢₜ consecutive base-pairs on either side, such that each child would have at least Nₛₚₗᵢₜ nucleotides. An eligible split-point is selected so as to minimize the difference in the size of the children, ∥sₖ^{l}|−|sₖ^{r}∥. Child node kₗ inherits from parent node k the substructure sₖ^{l} augmented by dummy nucleotides that approximate the influence of its sibling in the context of their parent. Dummy nucleotides are defined by extending the newly-split duplex stem across the split-point by Hₛₚₗᵢₜ base pairs (|sₖ_{ₗ}|=|sₖ^{l}|+2Hₛₚₗᵢₜ). All nucleotides in root nodes are termed “native nucleotides”. Nucleotides that are native in a parent are inherited as native in a child (|sₖ_{ᵢ}^{native}|=|sₖ^{l}∩sₖ^{native}|). Nucleotides that are dummy in a parent are inherited as dummy in a child (|sₖ_{ⱼ}^{dummy}|=sₖ^{l}∩sₖ^{dummy}+2Hₛₚₗᵢₜ). See FIG. 2 for an example of hierarchical structure decomposition. In FIG. 2, a selected split-point within each parent is denoted by a solid line. The dummy nucleotides within each child are depicted in light grey. The native nucleotides within each structure are depicted in black. Hₛₚₗᵢₜ=2, Nₛₚₗᵢₜ=20 in this example.

Decomposition of the sequence, φₖ, is performed in accordance with decomposition of structure sₖ. If the maximum depth of a leaf in the forest of binary trees is D, any nodes with depth d<D that lack an eligible split-point are replicated at each depth down to D so that all leaves have depth D. Let Λdenote the set of all nodes in the forest. Let Λ_{d} denote the set of all nodes at depth d. Let Λ_{d,j} denote the set of all nodes at depth d resulting from decomposition of complex j. Each nucleotide in complex j is native in exactly one nodal structure, sₖεs_{Λ}_{_{d,j}}, at any depth dε{1, . . . , D}.

Test Tube Ensemble Defect Estimation from Nodal Contributions.

The nodal test tube ensemble defect estimation module is configured to estimate the ensemble defect of one or more candidate nucleic acid molecules over the ensemble of a collection of nucleic acid molecules in a theoretical test tube based on the contributions of each nodal estimate. Evaluation of the test tube ensemble defect (equation (4)) at the root level of the forest requires calculation of the defect contribution (equation (5)) of each complex in the active complex Ψ_{active}. The O(|Ψ∥φ|ₘₐₓ³) time complexity for this calculation results from the Θ(|φⱼ|³) dynamic programs used to calculate the partition function, Qⱼ, and equilibrium pair probability matrix, Pⱼ, for each complex jεΨ. To reduce the cost of evaluating candidate sequences, here, we derive decompositions of the relevant physical quantities so that defect contribution of each complex (equation (5)) can be estimated less expensively using nodal contributions calculated at any depth dε{2, . . . , D} within its decomposition forest.

For each complex jεΨ, the cost of estimating the defect contribution cⱼ at level d is dominated by calculation of the nodal partition function, Qₖ, and nodal pair probability matrix, Pₖ, at cost Θ(|φₖ|³) for each node kεΛA_{d,j}. For an optimal decomposition, |φₖ| halves and |Λ_{d,j}| doubles at each level moving down the tree, so the cost of estimating cⱼ at level d can be a factor of ½^{2d-2} lower than the cost of calculating cⱼ exactly at the root. Hence, for maximum efficiency, all candidate mutations are evaluated by estimating the test tube ensemble defect at the leaf level of the forest (depth d=D). As subsequences are merged toward the root level, the test tube ensemble defect is estimated at intermediate depths in the forest.

The accuracy of the defect estimate will depend on the equilibrium structural properties of the sequence. If a split-point partitions a parent structure within a duplex that is predominantly well-formed at equilibrium, the physical properties of the parent can be accurately estimated based on the physical properties of the native nucleotides in its children, because the children are relatively isolated from each other by the base pairs adjacent to the split-point. The role of the dummy nucleotides within each child is to approximate the stabilizing influence of the missing sibling on the base pairs adjacent to the split-point. As the quality of the sequence design improves, the quality of the decomposition approximation will also improve as the duplex containing the split-point increasingly dominates at equilibrium The accuracy of the decomposition breaks down if there is crosstalk when sibling sequences are merged within a parent; crosstalk can destabilize the duplex containing the split-point, undermining the validity of the decomposition. The utility of root defect estimation hinges on the assumption that sequence space is sufficiently rich that subsequences within the decomposition forest will often not exhibit crosstalk when merged to the root.

The hierarchical mutation procedure exploits root defect estimation when crosstalk is absent, and eliminates crosstalk when it does arise during subsequence merging.

The following sections describe how to calculate each of the nodal contributions at any level dε{2, . . . , D} so as to efficiently and accurately estimate the complex contributions, c_{Ψ}_{_{active}}, to the test tube ensemble defect. Also described below is how to construct the complex partition function estimates \tilde{Q}_{Ψ}_{_{active}}, using nodal partition functions, Q_{Λ}_{_{d}}, and nodal pair probability matrices, P_{Λ}_{_{d}}. Complex concentration estimates, \tilde{x}_{Ψ}_{_{active}}, are then calculated based on \tilde{Q}_{Ψ}_{_{active}}, using deflated mass constraints to model the effect of the neglected off-target complexes in Ψₚₐₛₛᵢᵥₑ. Complex ensemble defect estimates, ñ_{Ψ}_{ₒₙ} are calculated based on P_{Λ}_{_{d}}. These estimates are then used to calculate the defect estimates, \tilde{c}_{Ψ}_{_{active}}, which are summed to produce the test tube ensemble defect estimate, \tilde{C}.

### Estimation of the Complex Partition Function.

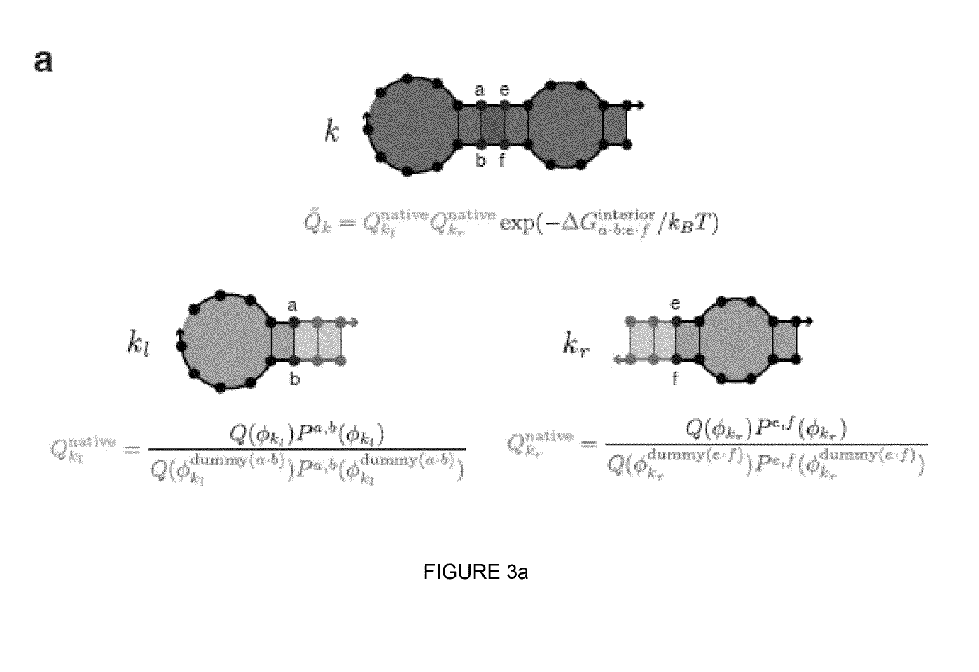

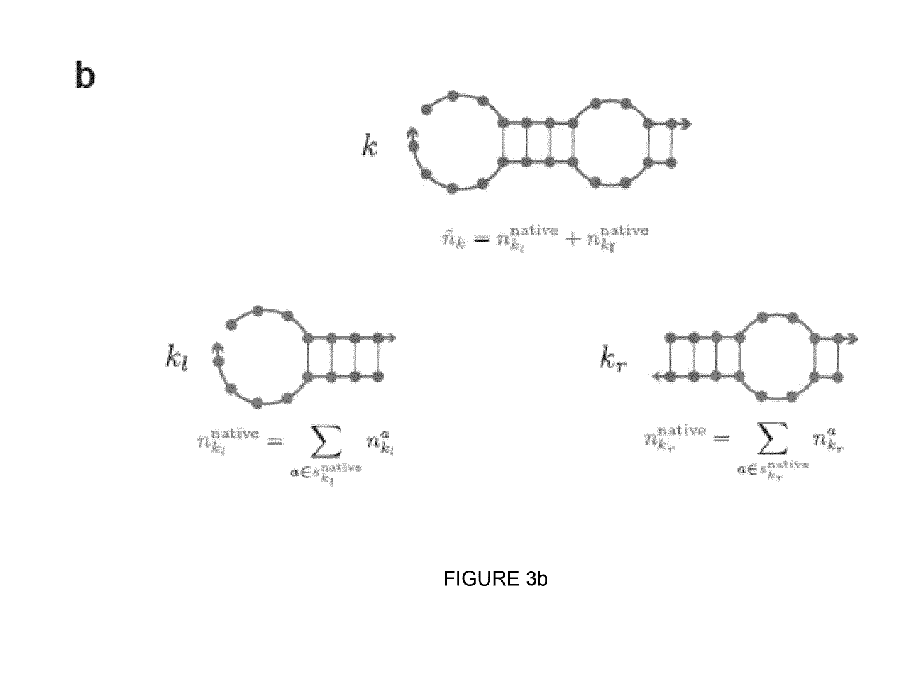

The complex partition function module is configured to estimate the partition function for a root node in a decomposition tree. We begin by calculating the complex partition function estimate, \tilde{Q}ⱼ, for each complex jεΨ_{active} in terms of partition function contributions evaluated efficiently at the nodes kεΛ_{d,j} at any level dε{2, . . . , D}. This decomposition is illustrated for parent node k and its children kₗ and kᵣ in FIG. 3a.

The utility of this approach hinges on the assumption that the base pairs on either side of a split-point are predominantly well-formed at equilibrium, so that the partition functions of two sibling nodes are approximately independent and can be usefully combined to approximate the partition function of their parent node. Let Eₖ denote the set of native base pairs adjacent to decomposition split-points in node k. For each base pair a·bεEₖ, let φₖ^{dummy(a·b)} denote the sequence of a·b and all the dummy nucleotides on the other side of the split-point. The native partition function for node k is then

$${Q}_{k}^{native} \approx Q ( φ k ) {\prod }_{a \cdot b ∈ {B}_{k}}^{ } \frac{{P}^{a , b} ( φ k )}{Q ( {φ}_{k}^{dummy ( a \cdot b )} ) {P}^{a , b} ( {φ}_{k}^{dummy ( a \cdot b )} )} . \qquad ( 8 )$$

where the approximation follows from the assumption that the equilibrium probabilities for the base pairs in Eₖ are independent; the expression becomes exact if Eₖ contains only one base pair, and in the limit as the equilibrium probabilities of the base pairs in Eₖ approach unity. The partition functions, Q(φₖ) and Q(φₖ^{dummy(a·b)}), and the equilibrium base-pairing probability matrices, P(φₖ) and P(φₖ^{dummy(a·b)}), are calculated using dynamic programs suitable for complexes containing arbitrary numbers of strands.

Note that the periodic strand repeat, vⱼ of complex j is defined as the number of different rotations of the polymer graph that map strands of the same type to each other (e.g., vⱼ=4 for complex AAAA, vⱼ=3 for complex ABABAB, vⱼ=2 for ABAABA). For complexes in which all strands are distinct, vⱼ=1. However, complexes containing multiple copies of the same strand may have vⱼ>1, in which case the dynamic program that is used to calculate the partition function of complex j will be incorrect due to symmetry and overcounting errors that are different for different structures in Γⱼ. Fortunately, these errors interact in such a way that they can be exactly and simultaneously corrected by dividing the calculated partition function by the integer vⱼ

Q(φⱼ)=Q_{calc}(φⱼ)/vⱼ.

When employing the dynamic program to calculate the nodal partition functions for kεΛ_{d,j}, it is important to correct each of these values using vⱼ.

Next, the system reconstructs the approximate partition function for complex j from the native partition functions of all descendant nodes at level d. Let F_{d,j} denote the set of base-pair stacks sandwiching the split-points in the decomposition of complex j at depth d. Each of these base-pair stacks a·b:e·f is an interior loop whose free energy, ΔG_{a·b:e·f}^{interior}, is not incorporated in the native partition functions calculated for the nodes on either side of the split point. The complex partition function estimate is then

$${\tilde{Q}}_{j} = {\prod }_{k ∈ {Λ}_{d , j}}^{ } {Q}_{k}^{native} {\prod }_{( a \cdot b \text{:} e \cdot f ) ∈ {F}_{d , j}}^{ } exp ( - Δ {G}_{a \cdot b \text{:} e \cdot f}^{interior} / {k}_{B} T ) , \qquad ( 9 )$$

representing the product of the native partition functions jεΛ_{d,j} and the additional contributions from the interior loops a·b:e·f at the split-points. This estimate becomes exact in the limit as the equilibrium probabilities of the base-pairing stacks in F_{d,j} approach unity.
Complex Concentration Estimate using Deflated Mass Constraints

After calculating the set of complex partition function estimates, \tilde{Q}_{Ψ}_{_{active}}, based on the nodal partition function contributions at level d, the corresponding equilibrium complex concentration estimates, \tilde{x}_{Ψ}_{_{active}}, may be found by solving the convex programming problem shown above for equation (1). To impose the conservation of mass constraints (equation (1b)), the total concentration of each strand species, iεΨ⁰, is specified. The total strand concentrations follow from the target concentration and strand composition of each on-target complex jεΨₒₙ:

$${x}_{i}^{0} = {\sum }_{j ∈ {Ψ}_{on}}^{ } {A}_{i , j} {y}_{j} ∀ i ∈ {Ψ}^{0} . \qquad ( 10 )$$

Initial sequence optimization is performed on a decomposition forest that contains only the on-target complexes in Ψ_{active}, but ultimately, the system tries to satisfy the test tube stop condition (equation (6)) for the full set of complexes in Ψ, including the off-targets in Ψₚₐₛₛᵢᵥₑ. Recall that the off-targets in Ψₚₐₛₛᵢᵥₑ do not contribute directly to the sum used to calculate the test tube ensemble defect (equation (4)), but contribute indirectly by forming at positive concentrations, causing concentration defects for complexes in Ψ_{active} as a result of conservation of mass. Hence, we can pre-allocate a portion of the permitted test tube ensemble defect, fₛₜₒₚyₙₜ, to the neglected off-target complexes in Ψₚₐₛₛᵢᵥₑ by deflating the total strand concentrations used to impose the mass constraints (equation (1b)) in calculating the equilibrium concentrations \tilde{x}_{Ψ}_{_{active}}.

Following this approach, if Ψₚₐₛₛᵢᵥₑ≠Ø, we make the assumption that the complexes in Ψₚₐₛₛᵢᵥₑ consume a constant fraction of each total strand concentration:

$${\sum }_{j ∈ {Ψ}_{passive}}^{ } {A}_{i , j} {\tilde{x}}_{j} = {f}_{passive} {f}_{stop} {\sum }_{j ∈ {Ψ}_{on}}^{ } {A}_{i , j} {y}_{j} ∀ i ∈ {Ψ}^{0} ,$$

corresponding to a total mass allocation of fₚₐₛₛᵢᵥₑfₛₜₒₚyₙₜ to the neglected off-targets in Ψₚₐₛₛᵢᵥₑ.

To calculate the equilibrium concentrations of the complexes in Ψ_{active} via (equation (1)), we therefore use the deflated strand concentrations:

$$\begin{matrix}{x}_{i}^{0} = ( 1 - {f}_{stop} {f}_{passive} ) {\sum }_{j ∈ {Ψ}_{on}} {A}_{i , j} {y}_{j} & ∀ i ∈ {Ψ}^{0}\end{matrix} \qquad ( 11 )$$

in place of the full strand concentrations (equation (10)). For each complex jεΨ_{active}, the concentration estimate, \tilde{x}ⱼ, is passed to the nodes in the subtree of complex j at level d:

xₖ=\tilde{x}ⱼ∀kεΛ_{d,j}

Nodal concentrations are useful for representing the test tube ensemble defect estimate as a sum of nodal (rather than complex) contributions.

### Complex Ensemble Defect Estimate.

The complex ensemble defect estimate, ñⱼ, is calculated for each complex jεΨ_{active} active based on nodal defect contributions, nₖ, calculated efficiently at the nodes kεΛ_{d,j} at any level dε{2, . . . , D}. This decomposition is illustrated for parent node k and its children kₗ and kᵣ in FIG. 3b.

Because each nucleotide in complex j is native in exactly one node kεΛ_{d,j}, the system can approximate the complex ensemble defect as the sum of the native nodal defect contributions at any depth in the subtree. The nodal pair probability matrix, Pₖ (with entries for both native and dummy nucleotides), was previously calculated in order to estimate the nodal partition function contribution (equation 8).

For any node kεΛ_{d,j}, the contribution of nucleotide aεs^{k} to the nodal defect is given by

$${n}_{k}^{a} = 1 - {\sum }_{1 \leq b \leq \vert {s}_{k} \vert + 1} {P}_{k}^{a , b} {S}_{k}^{a , b}$$

and the native nodal defect contribution is:

$${n}_{k}^{native} = {\sum }_{a ∈ {s}_{k}^{native}} {n}_{k}^{a} .$$

Based on nodal contributions at depth d, the complex ensemble defect estimate for any complex jεΨ_{active} is then:

$${\tilde{n}}_{j} = {\sum }_{k ∈ {Λ}_{d , j}} {n}_{k}^{native} .$$

This estimate becomes exact in the limit as the equilibrium probabilities of the base pairs sandwiching the decomposition split-points approach unity.

### Test Tube Ensemble Defect Estimate

Having calculated the complex concentration estimates, \tilde{x}_{Ψ}_{_{active}}, and the complex ensemble defect estimates, ñ_{Ψ}_{_{active}}, based on nodal contributions at any depth dε{2, . . . , D}, the contribution of complex jεΨ_{active} to the test tube ensemble defect is

\tilde{c}ⱼ=ñⱼmin(\tilde{x}ⱼ,yⱼ)+|sⱼ|max(yⱼ−\tilde{x}ⱼ,0), (12)

and a test tube ensemble defect module can then calculate the test tube ensemble defect as:

$$\tilde{C} = {\sum }_{j ∈ {Ψ}_{active}} {\tilde{c}}_{j} . \qquad ( 13 )$$

This sum can equivalently be expressed as a sum over nodal contributions at depth d. The test tube ensemble defect associated with nucleotide a in node kεΛ_{d} is

cₖ^{a}=nₖ^{a}min(xₖ,yₖ)+max(yₖ−xₖ,0)lem

so the native nodal defect contribution for node k is

$${c}_{k}^{native} = {\sum }_{a ∈ {s}_{k}^{native}} {c}_{k}^{a}$$

and the test tube ensemble defect estimate (equation (13)) becomes:

$$\tilde{C} = {\sum }_{k ∈ {Λ}_{d}} {c}_{k}^{native} . \qquad ( 14 )$$

The total defect permitted by the test tube stop condition (equation (6)) can be allocated proportionally to the nodes at depth d in the decomposition forest:

cₖ^{stop}≡fₛₜₒₚ|sₖ^{native}|yₖ∀kεΛ_{d} (15)

so that the nodal defect allocations sum to the total permitted test tube ensemble defect

$${C}_{stop} = {\sum }_{k ∈ {Λ}_{d}} {c}_{k}^{stop} .$$

During hierarchical sequence optimization, candidate sequences are evaluated using

the thresholded test tube ensemble defect estimate:

$${\tilde{C}}_{thresh} = {\sum }_{k ∈ {Λ}_{d}} max ( {c}_{k}^{stop} , {c}_{k}^{native} ) \qquad ( 16 )$$

in place of (equation (14)) to drive proportional defect allocation across the nodes at each level in the decomposition forest.

### Leaf Mutation

To minimize computational cost, all candidate mutations are preferably evaluated by a leaf mutation calculation module at the leaf nodes, kεΛ_{D}, of the decomposition forest. Leaf mutation terminates successfully if the leaf stop conditions,

cₖ^{native}≦cₖ^{stop}{kεΛ_{D}, (17)

are all satisfied. The multiple leaf stop conditions collectively enforce the single test tube stop condition (equation (6)) and further mandate consistent design quality across the leaves. A candidate mutation is accepted if it decreases the thresholded test tube ensemble defect estimate (equation (16)) and rejected otherwise. Let F_{D} denote the set of leaves that do not yet satisfy the leaf stop condition (equation (17)). The thresholded test tube ensemble defect is compatible with the leaf stop conditions in the sense that a candidate mutation is accepted if and only if it reduces the defect contribution of the leaves in F_{D}.

In some embodiments, defect weighted mutation sampling is performed by selecting nucleotide a for mutation from amongst those leaves kεF_{D} with probability proportional to the contribution of nucleotide a to the defect contribution of these leaves:

$${c}_{k}^{a} / {\sum }_{k ∈ {F}_{D}} {c}_{k}^{native} .$$

If the selected candidate mutation position is subject to complementarity constraints implied by the design problem specification, either via complementary sequence domains or via base-pairing within any on-target structure, the candidate mutation respects the constraint in one of three strengths: 1) strong complementarity (default): constrained nucleotides are selected randomly from a uniform distribution of Watson-Crick pairs, b) medium complementarity: constrained nucleotides are selected randomly from a uniform distribution of Watson-Crick and wobble pairs, c) weak complementarity: constrained nucleotides are selected randomly from a uniform distribution of Watson-Crick pairs, wobble pairs, and mismatches. For design problems where on-target structures place competing demands on the test tube ensemble defect, permitting weak complementarity permits the process to increase the defect contribution in one part of a design in order to reduce the ensemble defect of the test tube as a whole (e.g., see the example of FIG. 12).

A candidate sequence \hat{φ}_{Λ}_{_{D}} is evaluated via calculation of the thresholded test tube ensemble defect, \tilde{C}ₜₕᵣₑₛₕ, if the candidate mutation, ξ, is not in the set of previously rejected mutations, γₘᵤₜₐₜₑ (position and sequence). The set, γₘᵤₜₐₜₑ, is updated after each unsuccessful mutation and cleared after each successful mutation. The counter mₖ^{mutate} is used to keep track of the number of consecutive failed mutation attempts for each leaf. The counter mₖ^{mutate} is incremented for leaves with φₖ≠\hat{φ}ₖ after each unsuccessful mutation and reset to zero for leaves with φₖ≠\hat{φ}ₖ after each successful mutation. Leaf mutation terminates unsuccessfully if each leaf that fails to satisfy the leaf stop condition (equation (17)) undergoes Mₘᵤₜₐₜₑ|sₖ^{native}| consecutive unfavorable mutation attempts (i.e., mₖ^{mutate}≧Mₘᵤₜₐₜₑ|sₖ^{native}|). The outcome of leaf mutation is the set of leaf sequences, φ_{Λ}_{_{D}}, corresponding to the lowest encountered \tilde{C}ₜₕᵣₑₛₕ.

### Leaf Reoptimization

After leaf mutation terminates, if any leaves fail to satisfy the leaf stop condition (i.e., F_{D}≠Ø), leaf reoptimization commences by the leaf reoptimization module. The counter mₖ^{leaf} is used to keep track of the number of times that leaf k is reoptimized. During each round of leaf reoptimization, the leaf kεF_{D} with the minimal mₖ^{leaf} is reseeded with a random initial sequence and a new round of leaf mutation is performed. After leaf mutation terminates, the counter mₖ^{leaf} is incremented for any leaf whose sequence has changed. The reoptimized candidate sequences, \hat{φ}_{Λ}_{_{D}}, are accepted if they decrease \tilde{C}ₜₕᵣₑₛₕ and rejected otherwise. Leaf reoptimization terminates successfully if F_{D}=Ø or unsuccessfully if each leaf kεF_{D} has exhausted M_{leaf} reoptimization attempts (i.e., mₖ^{leaf}≧M_{leaf}). The outcome of leaf reoptimization is the set of leaf sequences, φ_{Λ}_{_{D}}, corresponding to the lowest encountered \tilde{C}ₜₕᵣₑₛₕ.

### Subsequence Merging and Parent Reoptimization

After leaf reoptimization terminates, parent nodes at depth d=D−1 merge their left and right child sequences to create the set of candidate sequences \hat{φ}_{Λ}_{_{d}}. The counter mₖ^{opt} is used to keep track of the number of times that parent k is optimized, and is incremented for each parent with φₖ≠\hat{φ}ₖ following a merge. The nodal defect contributions, ĉ_{Λ}_{_{d}}, are calculated for the parents at depth d and the candidates sequences, \hat{φ}_{Λ}_{_{d}}, are accepted if they decrease \tilde{C}ₜₕᵣₑₛₕ calculated at depth d and rejected otherwise. If each parent at depth d satisfies the parental stop condition:

cₖ^{native}≦max(cₖ_{ₗ}^{stop},cₖ_{ₗ}^{native})+max(cₖ_{ᵣ}^{stop},cₖ_{ᵣ}^{native}) (18)

or if all parents at level d have exhausted Mₒₚₜ optimization attempts (i.e., mₖ^{opt}≧Mₒₚₜ), merging continues up to the next level in the forest. Otherwise, failure to satisfy the parental stop condition implies the existence of emergent defects resulting from crosstalk between child sequences. In this case, the parent node at depth d with the minimal mₖ^{opt} that also fails to satisfy the parental stop condition (equation (18)), is selected for reoptimiziation (and labeled kᵣₑₒₚₜ).

To reoptimize parent node kᵣₑₒₚₜ at depth d, the current sequences at depth d are pushed down to all nodes below depth d, and the counter, mₖ^{opt}, is reset to zero for all nodes below depth d. Let Fₖ denote the set of native nucleotides in parent kᵣₑₒₚₜ, that are partitioned to leaf k. Parent kᵣₑₒₚₜ performs defect weighted leaf sampling by selecting a leaf k within its subtree with probability:

$${\sum }_{a ∈ {F}_{k}} {c}_{{k}_{reopt}}^{a} / {c}_{{k}_{reopt}}^{native} .$$

The selected leaf (labeled k_{reseed}) is reseeded to a random initial sequence and a new round of leaf mutation and leaf reoptimization is performed. Reseeding with a random initial sequence is based on the assumption that sequence space is sufficiently rich that emergent defects are atypical and can reliably be eliminated by designing a different leaf sequence. Following leaf reoptimization, merging begins again. Subsequence merging and reoptimization terminate successfully if all root nodes satisfy the parental stop condition (equation (18)). The outcome of subsequence merging and reoptimization are the sequences φ_{Ψ}_{_{active}}, corresponding to the lowest encountered \tilde{C}ₜₕᵣₑₛₕ calculated at depth d=1.

Focusing Effort within the Decomposition Forest

To focus mutation effort in portions of the decomposition forest where it is most likely to reduce the test tube ensemble defect, we define the set of nodes, Ω^{focus}. Initially, all nodes in the decomposition forest, kεΛ, are placed in Ω^{focus}. During leaf reoptimization, Ω_{D}^{focus} contains only those leaves whose sequences were changed by the most recent leaf reseeding. During parent reoptimization following a failed merge at level d, Ω_{d}_{ᵣₑₒₚₜ}^{focus} is emptied for all levels dᵣₑₒₚₜ>d. When candidate sequences are accepted, Ω^{focus} is updated to include any nodes whose sequences have changed.

To avoid expending undue effort on nodes that exhausted reoptimization attempts during a previous traversal of the decomposition forest, leaf mutation, leaf reoptimization, and parent reoptimization all focus on nodes in Ω_{focus}, as detailed in the pseudocode in the attached appendix. Leaf mutation is restricted to leaves in the set:

Ω_{D}^{mutate}={kεΩ_{D}^{focus}:cₖ^{native}>cₖ^{stop},mₖ^{mutate}<Mₘᵤₜₐₜₑ|sₖ^{native}|}

and terminates when Ω_{D}^{mutate} is empty. Leaf reoptimization is restricted to leaves in the set:

Ω_{D}^{leaf}={kεΩ_{D}^{focus}:cₖ^{native}>cₖ^{stop},mₖ^{leaf}<M_{leaf}}

and terminates when Ω_{D}^{leaf} is empty. Parent reoptimization at depth d is restricted to parents in the set:

Ω_{d}^{opt}={kεΩd^{focus}:cₖ^{native}>max(cₖ_{ₗ}^{stop},cₖ_{ₗ}^{native})+max(cₖ_{ᵣ}^{stop},cₖ_{ᵣ}^{native}),mₖ^{opt}<Mₒₚₜ}

and merging continues up the forest when Ω_{d}^{opt} is empty.

### Off-Target Evaluation, Decomposition and Destabilization.

Initial forest optimization is performed for the on-target complexes in Ψ_{active}, neglecting the off-target complexes in Ψₚₐₛₛᵢᵥₑ. At the termination of initial forest optimization, the test tube ensemble defect estimate (equation (13)) is \tilde{C} calculated at depth d=1. For this estimate, the complex defect contributions, \tilde{c}_{Ψ}_{_{active}}, are based on complex concentration estimates, \tilde{x}_{Ψ}_{_{active}}, calculated using deflated total strand concentrations (equation (11)) to create a built-in defect allowance for the effect of the neglected off-target in Ψₚₐₛₛᵢᵥₑ.

For the first time, the full test tube ensemble defect (equation (4)), C, is then calculated for all complexes in the complex Ψ. For this exact calculation, the complex defect contributions, c_{Ψ}, are based on complex concentrations, x_{Ψ}, calculated using the full strand concentrations (equation (10)).

Sequence design terminates successfully if the test tube ensemble defect satisfies either the test tube stop condition (equation (6)), or is no greater than the forest-estimated defect (equation (13)):

C≦max(Cₛₜₒₚ,\tilde{C}). (19)

This latter condition allows sequence design to terminate if the actual defect contribution resulting from the off-target complexes in Ψₚₐₛₛᵢᵥₑ is no greater than the built-in defect allowance resulting from deflation of the total strand concentrations during forest optimization. Otherwise, we have

C>\tilde{C} (20)

and the off-target complex jεΨₚₐₛₛᵢᵥₑ with the largest concentration is transferred from Ψₚₐₛₛᵢᵥₑ to Ψ_{active}. Because the off-target structure, sⱼ, is undefined and we require a structural basis for tree decomposition, we generate an off-target structure, sⱼ, that includes all base pairs a·b that form with equilibrium probability Pⱼ^{a,b}>pₛₚₗᵢₜ (for a specified pₛₚₗᵢₜε(0.5,1.0)) between nucleotides a and b that are constrained to be complementary (either due to specification of complementary sequence domains or due to specification of an on-target structure containing a·b). The root defect estimate, \tilde{C}, is then recalculated (using deflated strand concentrations (equation (11)) if Ψₚₐₛₛᵢᵥₑ≠Ø). This process of transferring the highest-concentration off-target complex, j, from Ψₚₐₛₛᵢᵥₑ to Ψ_{active} generating an off-target structure sⱼ, and re-calculating the root defect estimate, \tilde{C}, is repeated until (equation (20)) no longer holds.

The new off-target structures Ψ_{inactive} are then hierarchically decomposed, the decomposition forest is augmented with new nodes at all depths, and forest reoptimization commences starting from the final sequences from the previous round of forest optimization. During forest reoptimization, the process actively attempts to destabilize the off-targets that were added to Ψ_{active}. This process of forest augmentation and reoptimization is repeated until (equation (19)) is satisfied, which is guaranteed to occur in the event that all off-targets are eventually added to Ψ_{active}. The sequence design process shown in the attached pseudocode appendix returns the sequences φ_{Ψ} that yielded the lowest encountered test tube ensemble defect, C. The appendix includes pseudocode for hierarchical test tube ensemble defect optimization. For a given set of target secondary structures, s_{Ψ}, and target concentrations, y_{Ψ}, a set of designed sequences φ_{Ψ}, is returned by the function call OptimizeTube (s_{Ψ}, y_{Ψ}, Ψ, Ψₒₙ, Ψ_{off}).

In one embodiment, the test tube design process described herein is coded in the C programming language. To reduce run-time for large jobs, the dynamic programs for evaluating the nodal partition function, Qₖ, and the nodal base-pairing probability matrix, Pₖ, can be parallelized using MPI. For parallel execution, each evaluation of Qₖ and Pₖ for node k with target structure sₖ is performed using a number of cores selected so as to approximately minimize run time based on node size, |sₖ|.

### EXAMPLES

### Standard Test Set

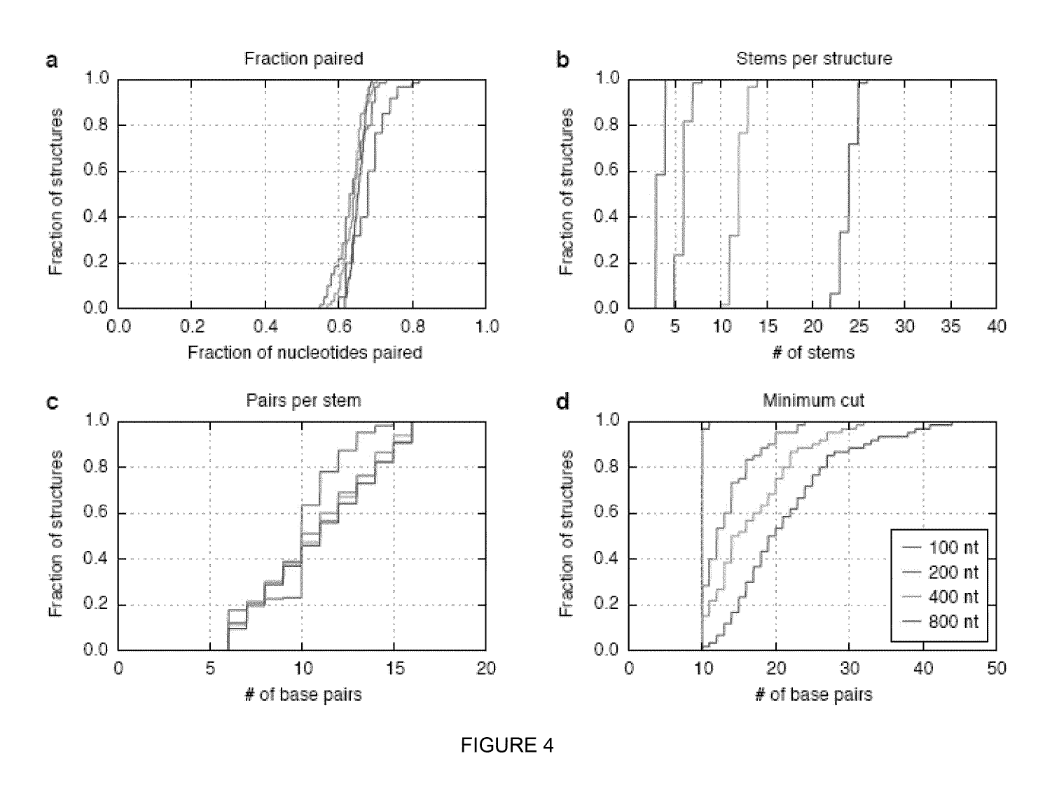

The performance of the test tube design process was demonstrated using a set of target test tubes. Within each target test tube, there was a single on-target tetramer with a target concentration of 1 μM. The off-targets were specified to be to all complexes of up to Lₘₐₓ=4 strands (excluding the on-target tetramer), corresponding to a total of 107 off-target complexes. The target structure for each on-target tetramer was randomly generated with stem and loop sizes randomly selected from a distribution of sizes representative of the nucleic acid engineering literature. Sixty on-target tetramers were generated for each target structure size |s|ε{100,200,400,800} nucleotides, corresponding to a total of 240 target test tubes. Within a tetramer, all strands were of the same length. The structural properties of these on-target tetramers are summarized in FIG. 4. For the design studies that follow, new target test tubes were generated from scratch. The design process was not tested on these target test tubes prior to generating the depicted results.

### Sequence Design Trials.

Design trials were run on a cluster of 2.53 GHz Intel E5540 Xeon® dual-processor/quad-core nodes with 24 GB of memory per node. Unless otherwise noted, trials were performed on a single computational core using the default process parameters of Table 1. Design quality is plotted as the normalized test tube ensemble defect, C/yₙₜ.

TABLE 1
DEFAULT PROCESS PARAMETERS.

| Parameter | RNA | DNA |
|---|---|---|
| Hₛₚₗᵢₜ | 2 | 3 |
| Nₛₚₗᵢₜ | 20 | 30 |
| Pₛₚₗᵢₜ | 0.9 | 0.9 |
| fₛₜₒₚ | 0.01 | 0.01 |
| fₚₐₛₛᵢᵥₑ | 0.01 | 0.01 |
| Mₒₚₜ | 10 | 10 |
| M_{leaf} | 3 | 3 |
| Mₘᵤₜₐₜₑ | 4 | 4 |

### Results

The primary test scenario is RNA sequence design at 37° C. with fₛₜₒₚ=0.01 (i.e., less than 1% of the nucleotides should be incorrectly paired within the test tube at equilibrium). Ten independent trials were performed for each of the 240 target test tubes in the standard test set.

Performance of Complex Design without Consideration of Off Target Complexes

In order to have a comparison with prior systems, an initial experiment was run to characterize the special case in which test tube design reduces to the earlier complex design: a target test tube containing one on-target complex and no off-target complexes. Once the performance of this method was determined, it could be used as a baseline for comparison against embodiments of the invention that utilize a test tube design process.

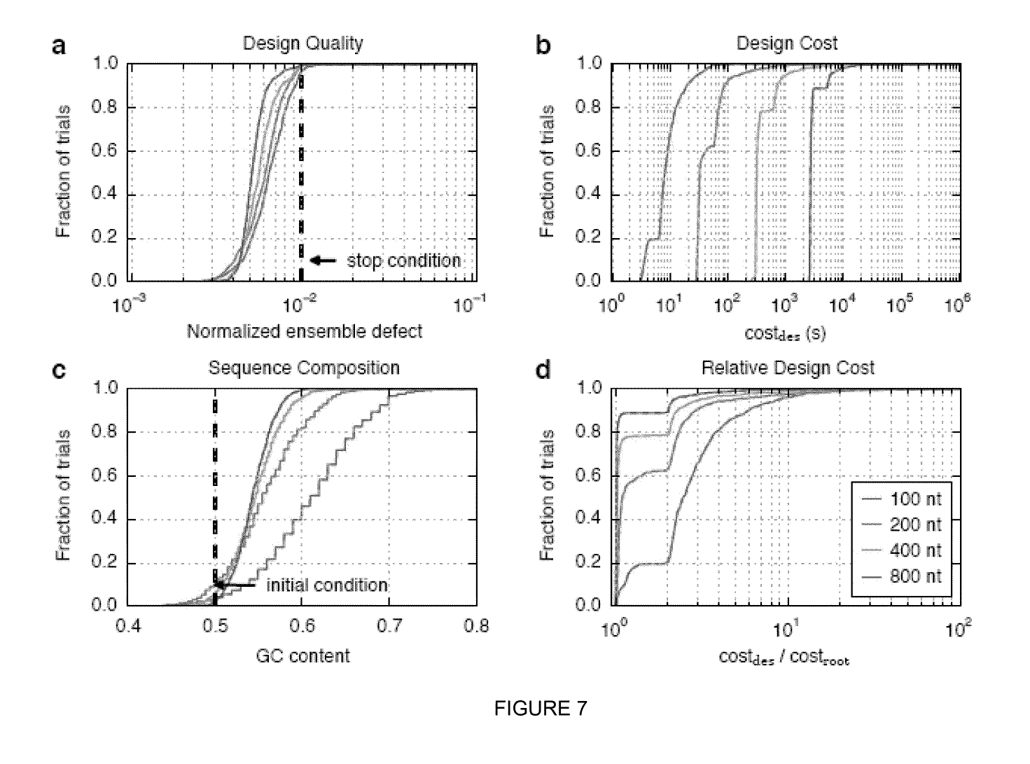

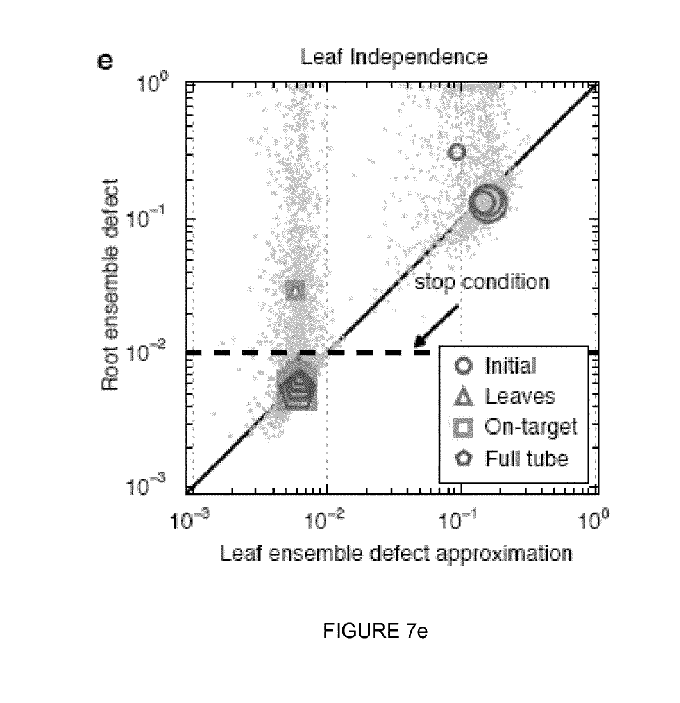

FIG. 7 includes a set of line graphs demonstrating that the performance of the test tube design process and the prior single-complex design process were essentially indistinguishable for the on-target structures in the standard test set. Typical designs surpassed the desired design quality (normalized ensemble defect ≦0.01; panel a). Typical design costs ranges from a fraction of a second for |s|=100 to 100 seconds for |s|=800 (panel b). Typical GC content was less than 60% starting from random initial sequences (panel c). As the depth of the decomposition tree increased with |s|, the relative design cost, c_{des} (|S|)/cₑᵥₐₗ (|s|), was found to decrease asymptotically towards the 4/3 optimality bound for typical design trials (panel d).

Complex Ensemble Defect Estimation within the On-Target Decomposition Tree

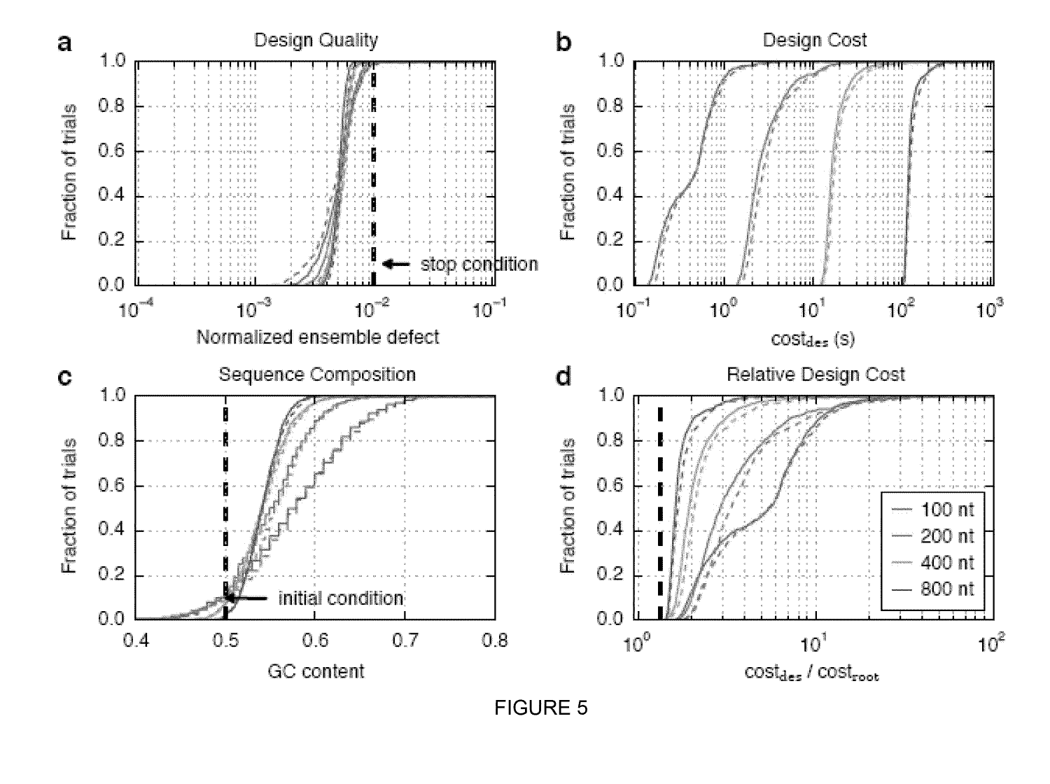

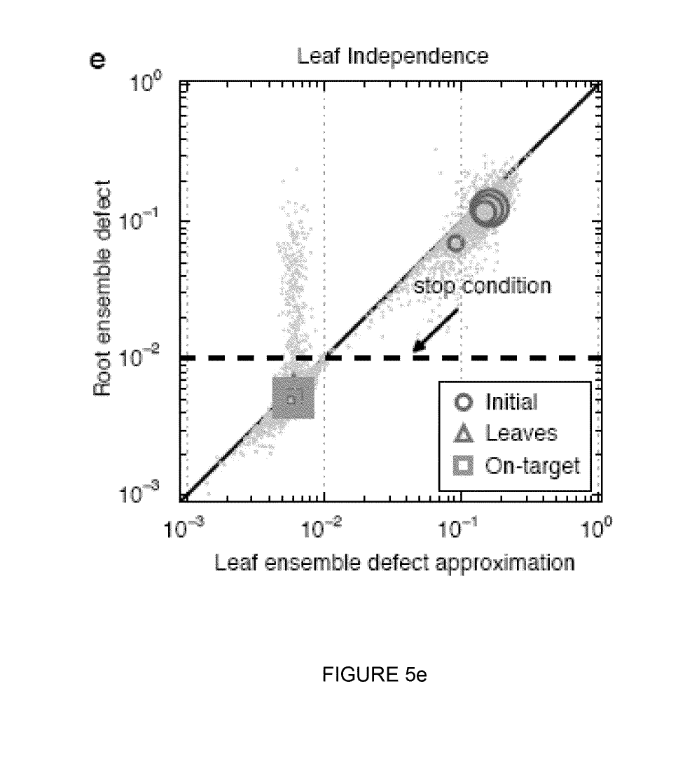

FIG. 5e compares the ensemble defect evaluated at the root of the on-target decomposition tree to the estimated ensemble defect based on physical quantities calculated efficiently at the leaves of the tree. These data reveal both the progression in design quality and the progression in the accuracy of defect estimation as tree optimization proceeds. Consistent with the performance of the earlier single-complex design process, three striking properties were observed. First, for a random initial sequence, the root defect was large and well-approximated by the leaf-estimated defect (data fall near the diagonal). Second, leaf-optimized sequences that were merged without reoptimization (Mₒₚₜ=1) were typically estimated to satisfy the stop condition (leaf-estimated defect ≦0.01) but failed to satisfy the root stop condition (root defect ≦0.01) due to emergent defects resulting from crosstalk between merged subsequences. These emergent defects were successfully eliminated during reoptimization of defective subtrees from new random initial subsequences, resulting in final sequence designs that satisfied the root stop condition (root defect ≦0.01).

Furthermore, for the final sequence designs, the leaf-estimated defect typically closely approximated the root defect, indicating that there was minimal crosstalk between merged subsequences and that dummy nucleotides in the leaves did a good job of approximating parental context.

### Performance for Test Tube Design Process

FIG. 7 demonstrates the performance of the test tube design process detailed herein on the standard test set of 240 target test tubes. Typical designs trials surpassed the desired design quality (normalized test tube ensemble defect ≦0.01; panel a). The cost of test tube design was considerably higher than for single-complex design because evaluation of the test tube ensemble defect required consideration of 107 off-target complexes in addition to the single on-target tetramer. Typical design cost ranged from a second for |s|=100 to approximately half an hour for |s|=800 (panel b). Typical GC content was less than 65% starting from random initial sequences (panel c).

As previously observed, as |s| increased, the cost of optimizing the on target decomposition tree approached 4/3 the cost of a single evaluation of the complex ensemble defect for the on-target (FIG. 5d). These costs however were negligible compared to the cost of evaluating the full test tube ensemble defect, including all 107 off-targets. Hence, if initial forest optimization (with Ψ_{active}=Ψₒₙ) yields a design that satisfies the test tube stop condition without requiring explicit off-target destabilization and forest reoptimization (i.e., augmentation of Ψ_{active} with off-targets that form at appreciable concentrations), the cost of test tube design should be almost indistinguishable from the cost of a single evaluation of the test tube ensemble defect.

Indeed, this is typically the case for test tubes containing an on-target structure with |s|ε{200,400,800} (panel d). For example, for |s|=800, approximately 70% of design trials required no off-target destabilization and hence only a single evaluation of the test tube ensemble defect. A further 20% of design trials required only one round of off-target destabilization and a total of two evaluations of the test tube ensemble defect, leading to the observed stair step structure in the cumulative histogram of relative design cost (panel d). For test tubes containing an on-target structure with |s|=100, off-target destabilization was typically required, and a typical design trial costs about three times the cost of a single evaluation of the test tube ensemble defect.

Test Tube Ensemble Defect Estimation within the Decomposition Forest

FIG. 7e compares the test tube ensemble defect evaluated at the root level of the decomposition forest with the leaf-estimated defect. These data reveal both the progression in design quality and the progression in the accuracy of root defect estimation as optimization of the decomposition forest proceeds for the full test tube design process. Because of the presence of off-targets within the test tube (unlike FIG. 5e), crosstalk between merged subsequences can result not only in structural defects within the on-target complex, but also in concentration defects due to appreciable formation of off-target complexes. As a result, it is more challenging to estimate the root defect and to satisfy the root stop condition. For test tubes containing an on-target with |s|=100 (plus 107 off-target complexes), emergent defects are typical (median above the diagonal) for random initial sequences, for leaf-optimized sequences (merged without reoptimization), and for sequences merged and reoptimized within the on-target decomposition tree (with Ψ_{active}=Ψₒₙ). Only after explicit off-target destabilization and forest reoptimization do sequences typically satisfy the root stop condition (root defect ≦100). For the final sequence designs, the leaf-estimated defect closely approximates the root defect (data near the diagonal).

### Importance of Destabilizing Off-Targets

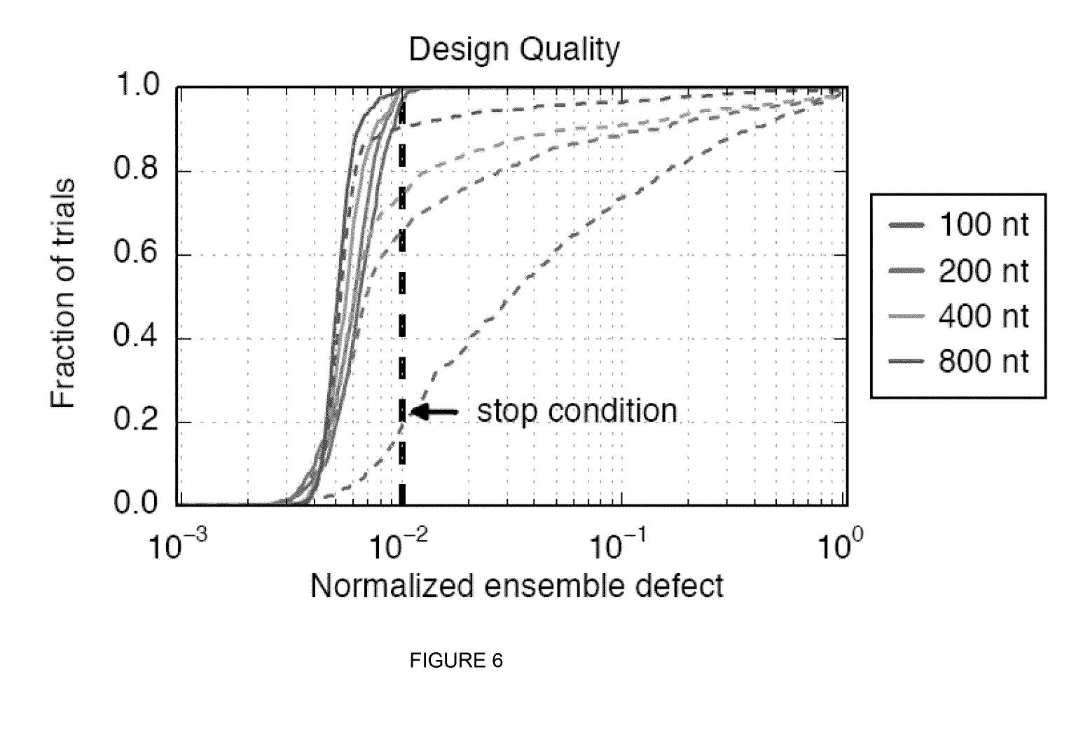

FIG. 6 is a line graph that compares the test tube ensemble defect for design trials performed without or with off-target destabilization (sequences from FIGS. 5 and 7). If sequence design is performed without off-targets in the test tube ensemble, the resulting sequences often fail to satisfy the test tube stop condition evaluated with off-targets in the ensemble (majority of trials for |s|=100, sizable minority of trials for |s|ε{200, 400, 800}). By contrast, sequences design with both on- and off-target complexes present in the test tube ensemble satisfied the test tube stop condition for nearly all design trials.

### Robustness to Model Perturbations

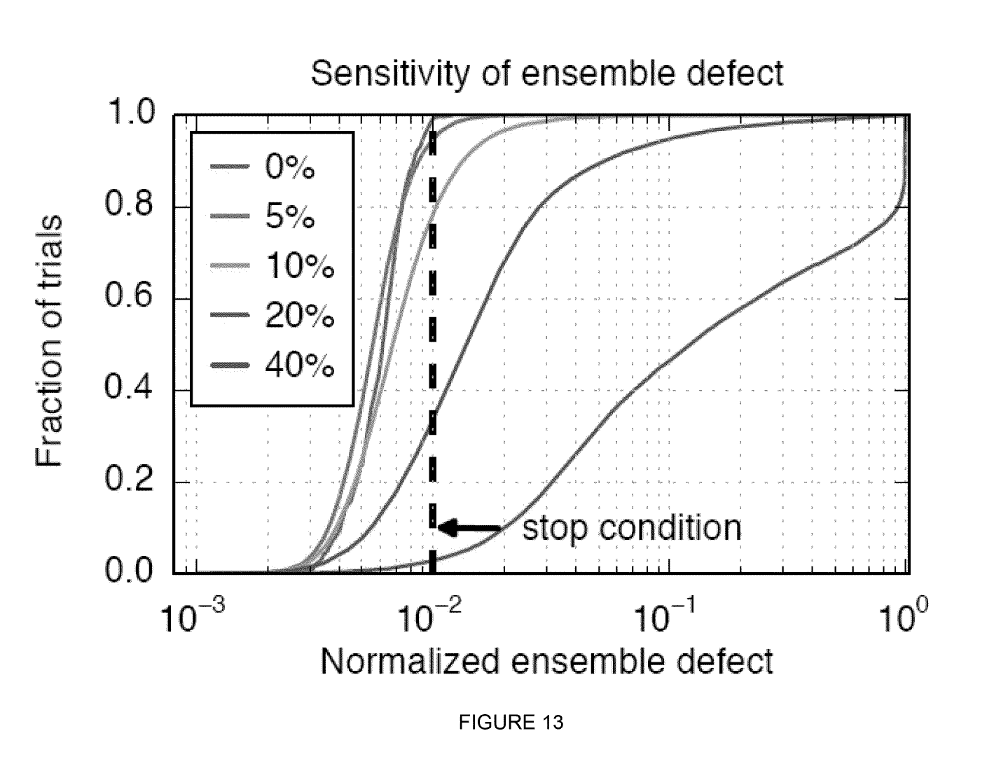

Methods of analyzing and designing equilibrium nucleic acid secondary structure depend on empirical free energy models. It is inevitable that the parameter sets in these models will continue to be refined. In order to make useful design predictions based on an approximate physical model, it is important that conclusions about design quality are robust to model perturbations. To assess the sensitivity of the test tube ensemble defect to model perturbations, we considered all 600 design trials for target test tubes with |s|=200. Each sequence design was evaluated using 100 perturbed parameter sets with each parameter perturbed by Gaussian noise with a standard deviation of 5, 10, 20, or 40 percent of the parameter absolute value (FIG. 13).

### Random Seed Composition.

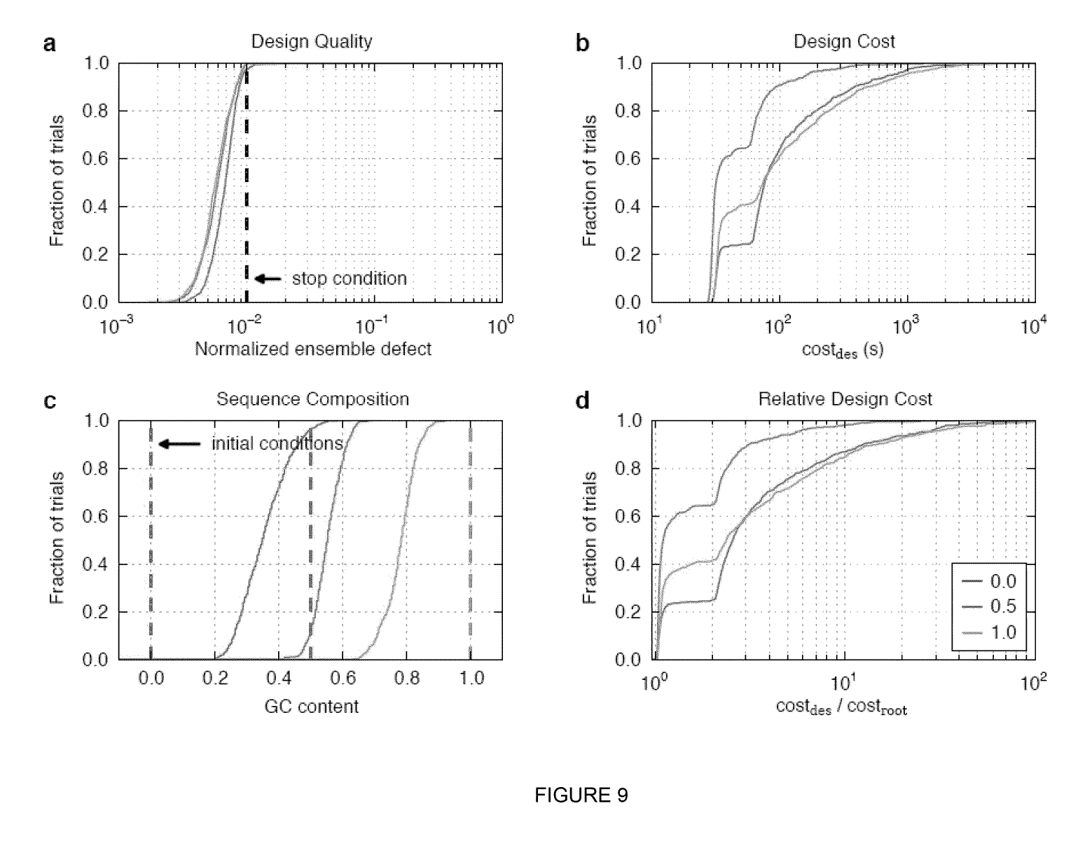

FIGS. 9a-d are line graphs that compare the process performance of the test tube design process using different GC contents for random seeding and reseeding.

### Design Material.

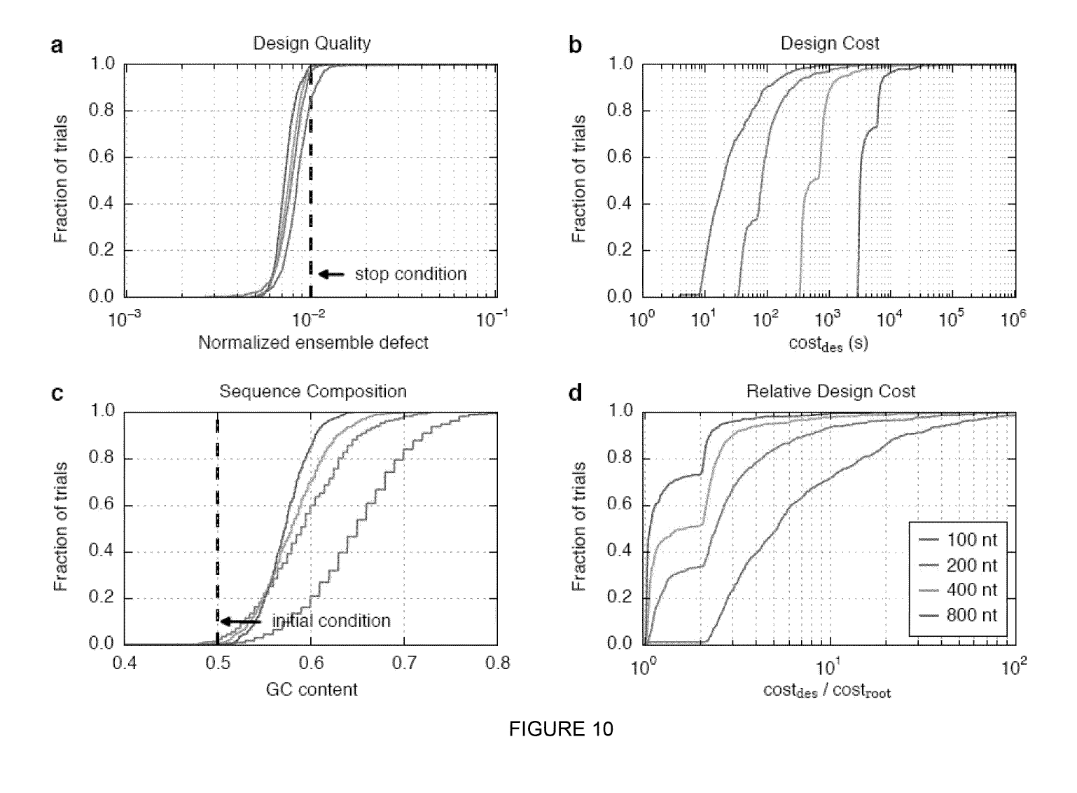

FIG. 10 compares RNA and DNA design. DNA designs were performed in 1M Na⁺ at 25° C. to reflect that DNA systems are typically engineered for room temperature studies.

### Parallel Efficiency and Speedup.

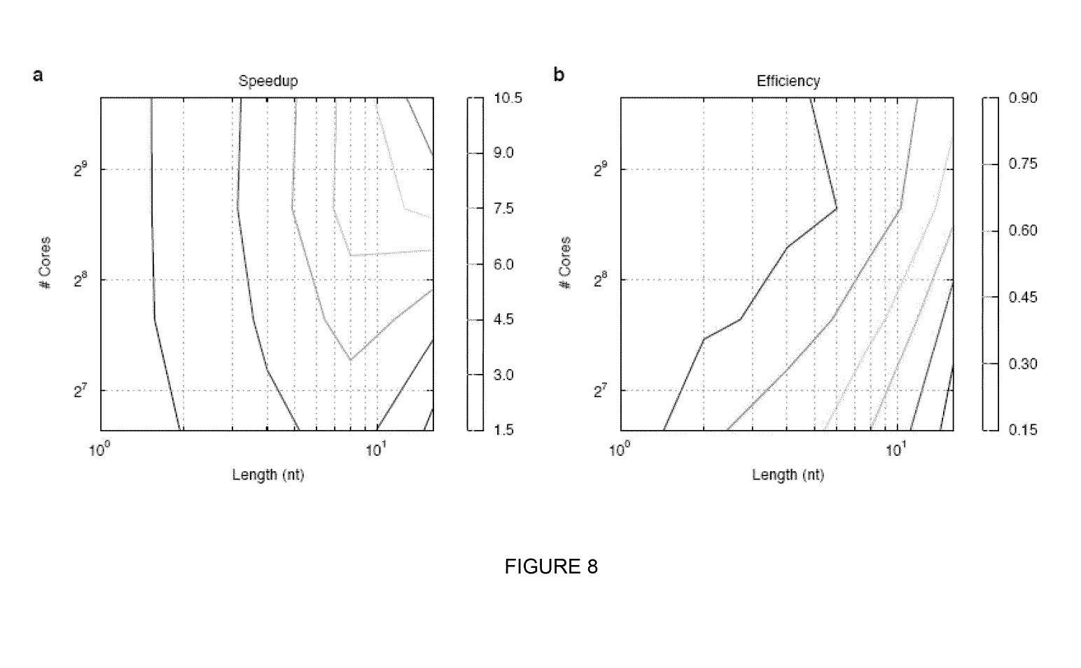

The contour plots of FIG. 8 demonstrate the parallel efficiency and speedup achieved using a parallel implementation of the test tube design process.

### Designing Competing On-Target Complexes

In the standard test set, there is only one on-target complex per test tube, so there is no disadvantage to stabilizing this complex to the maximum extent possible, since all off-target complexes have vanishing target concentration. However, if there are multiple on-target complexes competing for the same strands, then the process needs to look at balancing the relative stability of these competing on-target complexes. To examine this challenge, we considered target test tubes in which a strand was intended to form both a monomer hairpin and a dimer duplex (FIG. 12a), varying the target concentration of the monomer from 0 to 1 μM while keeping the total strand concentration fixed at 1 μM.

FIGS. 12 b and 12c demonstrate that typical design quality varies greatly depending on the target monomer concentration (i.e., depending on the desired relative stability of the monomer and dimer on-targets). For example, the process typically succeeded in producing designs for low/high monomer/dimer target concentrations but struggled to satisfy the stop condition for high/low monomer/dimer target concentrations. These designs were performed with strong sequence complementarity constraints, requiring nucleotides that were intended complements in one or more on-target structures to be Watson-Crick complements.

If the designs were performed with weak complementarity requirements, permitting the process to introduce wobble pairs or mismatches between intended complements, typical design performance significantly improved (FIG. 12de)

Because of the competition between on-target complexes, we revisited the question of robustness to model perturbations. The perturbation studies of FIGS. 12f and 12g demonstrate that the predicted design quality was typically robust to model perturbations for test tubes where one on-target dominates the other, but became more sensitive to model perturbations for test tubes where both on-targets were in competition at non-saturated target concentrations. Hence, for applications where on-targets are in competition, it is more likely that the relative stabilities of the on-targets will need to be fine-tuned to account for imperfections in the physical model. Many applications seek to saturate on-targets at maximum concentration and off-targets at vanishing concentration, reducing the sensitivity of computational predictions to perturbations in the model parameters.

Test Tube Design with Multiple On- and Off-Target Complexes

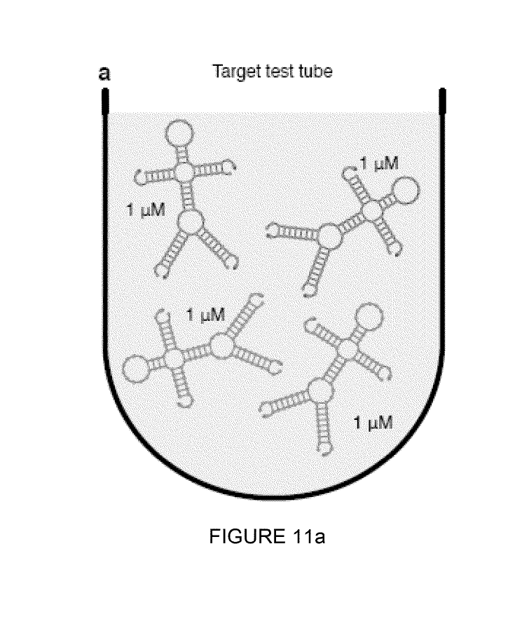

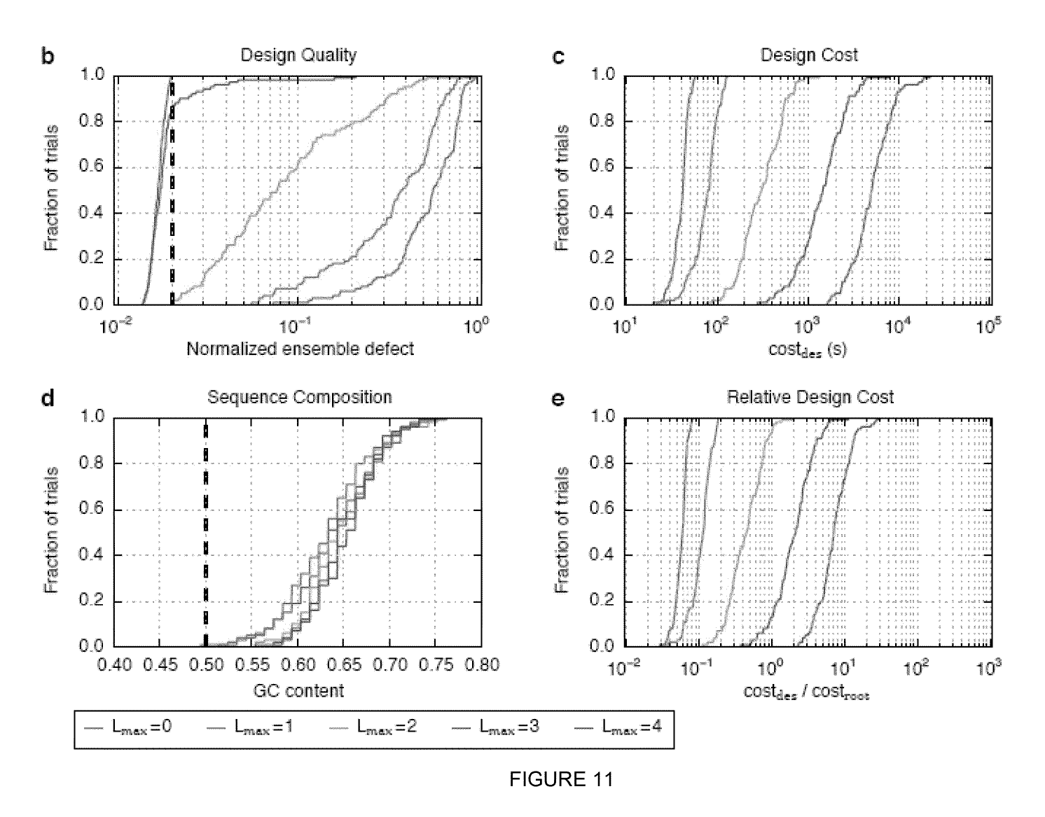

FIG. 11 demonstrates the performance of the process for target test tubes containing four on-target tetramers and different sets of off-target complexes (all off-target complexes up to size Lₘₐₓε{0,1,2,3,4}). If the design is performed without off-targets (Lₘₐₓ=0) or with all off-targets up to monomers or dimers, the typical design quality was poor. If the design was performed with all off-targets up to trimers or tetramers, typical design trials surpassed the desired design quality (normalized test tube ensemble defect ≦0.02; panel a). These results illustrate the importance of destabilizing off-target complexes during sequence design.

### CONCLUSION

As illustrated above, the test tube design process was found to provide a powerful framework for engineering nucleic acid base pairing to conform to a target secondary structure at a target concentration. The desired equilibrium base-pairing properties for candidate nucleic acid molecules in a predetermined environment (such as a dilute solution in a test tube) were specified as an arbitrary number of on-target complexes, each with a target secondary structure and target concentration, and an arbitrary number of off-target complexes, each with vanishing target concentration.

Given a theoretical target test tube, embodiments of the invention determine a test tube ensemble defect that quantifies the concentration of incorrectly paired nucleotides at equilibrium evaluated over the ensemble of the test tube. Embodiments of the test tube ensemble defect optimization process implements a positive design paradigm (stabilize on-targets) and a negative design paradigm (destabilize off-targets) at two levels: a) designing for the on-target structure and against the off-target structures within the structural ensemble of each on-target complex, and b) designing for the on-target complexes and against the off-target complexes within the ensemble of the test tube. Using the hierarchical mutation process described above, test tube designs involving multiple on- and off-targets for strand lengths of practical interest to the molecular programming and synthetic biology communities can be realized.

In the preceding description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

```
APPENDIX
OPTIMIZETUBE(s_{Ψ},y_{Ψ},Ψₒₙ,Ψ_{off})
  φ_{Ψ} ← INITSEQ(,S_{Ψ},Ψ)
  Ψ_{active}, Ψₚₐₛₛᵢᵥₑ ← Ψₒₙ, Ψ_{off}
  φ_{Λ},s_{Λ},y_{Λ},Λ,D ← DECOMPOSE(φ_{Ψ}_{_{active}},s_{Ψ}_{_{active}},y_{Ψ}_{_{active}})
  φ_{Ψ},C ← OPTIMIZEFOREST(φ_{Λ},s_{Λ},y_{Λ},D)
  C ← TUBEDEFECT(φ_{Ψ},s_{Ψ},y_{Ψ})
  \hat{φ}_{Ψ},C ← φ_{Ψ},C
  while Ĉ > max(Cₛₜₒₚ,\tilde{C})
    S_{Ψ}_{_{active}} ← AUGMENTACTIVE(s_{Ψ}_{_{active}},Ĉ,\tilde{C},\hat{φ}_{Ψ})
    φ_{Λ},s_{Λ},y_{Λ},Λ,D ← DECOMPOSE(φ_{Ψ}_{_{active}},s_{Ψ}_{_{active}},y_{Ψ}_{_{active}})
    \hat{φ}_{Ψ},Ĉ ← OPTIMIZEFOREST(φ_{Λ},s_{Λ},y_{Λ},D)
    Ĉ ← TUBEDEFECT(\hat{φ}_{Ψ},s_{Ψ},y_{Ψ})
    if Ĉ < C
      C,φ_{Ψ} ← Ĉ,\hat{φ}_{Ψ}
  return φ_{Ψ}
OPTIMIZEFORESTφ_{Λ},s_{Λ},y_{Λ},D)
  c_{Λ} ← ∞
  m_{Λ}^{opt ← 0}
  Ω^{focus} ← Λ
  Ω₁^{opt} ← Λ₁
  while Ω₁^{opt} ≠
    φ_{Λ}_{_{D}},C_{Λ}_{_{D}} ← OPTIMIZELEAVES(φ_{Λ}_{_{D}},s_{Λ}_{_{D}},y_{Λ}_{_{D}},Ω_{D}^{focus})
    Ω_{D}^{opt} ←
    d ← D − 1
    while d ≧ 1 and Ω_{d+1}^{opt} =
      \hat{φ}_{Λ}_{_{d}} ← MERGESEQ(φ_{Λ}_{_{d+1}})
      mₖ^{opt} ← mₖ^{opt} + 1 ∀k ∈ Λ_{d} : φₖ ≠ \hat{φ}ₖ
      \tilde{c}_{Λ}_{_{d}} ← NODALDEFECTS(\hat{φ}_{Λ}_{_{d}},s_{Λ}_{_{d}},y_{Λ}_{_{d}})
      if Σ_{k∈Λ}_{_{d}} max(cₖ^{native},cₖ^{stop}) <
              Σ_{k∈Λ}_{_{d}} max(cₖ^{native},cₖ^{stop})
        Ω_{d}^{focus} ← Ω_{d}^{focus} ∪ {k ∈ Λ_{d} : φₖ ≠ \hat{φ}ₖ}
        φ_{Λ}_{_{d}},c_{Λ}_{_{d}}← \hat{φ}_{Λ}_{_{d}},ĉ_{Λ}_{_{d}}
      else
        φ_{Λ}_{_{d+1}} ← SPLITSEQ(φ_{Λ}_{_{d}})
        c_{Λ}_{_{d+1}} ← NODALDEFECTS(φ_{Λ}_{_{d+1}},s_{Λ}_{_{d+1}},y_{Λ}_{_{d+1}})
      Ω_{d}^{opt} ← {k ∈ Ω_{d}^{focus},mₖ^{opt} < Mₒₚₜ and
        cₖ^{native} > max(cₖ_{ₗ}^{native},cₖ_{ₗ}^{stop}) + max(cₖ_{ᵣ}^{native},cₖ_{ᵣ}^{stop}
      if Ω_{d}^{opt} ≠
        kᵣₑₒₚₜ ← arg min_{k∈Ω}_{d}^{opt} mₖ^{opt}
        for d′ = d + 1, . . . ,D^{d}
          φ_{Λ}_{_{d′}} ← SPLITSEQ(φ_{Λ}_{_{d′−1}})
          c_{Λ}_{_{d′}} ← ∞
          m_{Λ}_{_{d′}}^{opt} ← 0
          Ω_{d′}^{focus} ←
        k_{reseed} ← WEIGHTEDLEAFSAMPLING(cₖ_{ᵣₑₒₚₜ}^{native},
            sₖ_{ᵣₑₒₚₜ}^{native},s_{Λ}_{_{D}}^{native})
        \hat{φ}_{Λ}_{_{D}} ← INITSEQ(φ_{Λ}_{_{D}},s_{Λ}_{_{D}},k_{reseed})
        Ω_{D}^{focus} ← {k ∈ Λ_{D} : φₖ ≠ φ_{K}}
        φ_{Λ}_{_{D}} ← \hat{φ}_{Λ}_{_{D}}
      d ← d − 1
  return φ_{Λ}_{₁}, Σc_{Λ}_{₁}
AUGMENTACTIVE(s_{Ψ}_{_{active}},C,\tilde{C},φ_{Ψ})
  while C < \tilde{C}
    ĵ ← j ∈ Ψₚₐₛₛᵢᵥₑ : xⱼ ≧ xₖ∀k ∈ Ψₚₐₛₛᵢᵥₑ
    Ψ_{active} ← {ĵ} ∪ Ψ_{active}
    Ψₚₐₛₛᵢᵥₑ ← Ψₚₐₛₛᵢᵥₑ \ {j}
    s^{ĵ} ← PAIRPROBSTRUCTURE(φ^{ĵ})
    ĉ ← NODALDEFECTS(φ_{Ψ}_{_{active}},s_{Ψ}_{_{active}},y_{Ψ}_{_{active}})
    \tilde{C} ← Σc
  return s_{Ψ}_{_{active}}
OPTIMIZELEAVES(φ_{Λ}_{_{D}},s_{Λ}_{_{D}},y_{Λ}_{_{D}},Ω_{D}^{focus})
  mₖ^{leaf} ← 0 ∀k ∈ Λ_{D}
  \hat{φ}_{Λ}_{_{D}},c_{Λ}_{_{D}} ← MUTATELEAVES(φ_{Λ}_{_{D}},s_{Λ}_{_{D}},y_{Λ}_{_{D}},Ω_{D}^{focus})
  mₖ^{leaf} ← mₖ^{leaf} + 1 ∀k ∈ Λ_{D} : φk ≠ \hat{φ}k
  Ω_{D}^{focus} ← Ω_{D}^{focus} ∪ {k ∈ Λ_{D} : φk ≠ \hat{φ}k}
  φ_{Λ}_{_{D}} ← φ_{Λ}_{_{D}}
  Ω_{D}^{leaf} ← {k ∈ Ω_{D}^{focus} : cₖ^{native} > cₖ^{stop}}
  while Ω_{D}^{leaf} ≠
    k_{reseed} ← arg min_{k∈Ω}_{D}^{leaf} mₖ^{leaf}
    \hat{φ}_{Λ}_{_{D}} ← INITSEQ(φ_{Λ}_{_{D}},s_{Λ}_{_{D}},k_{reseed})
    \hat{Ω}_{D}^{focus} ← {k ∈ Λ_{D} : φₖ ≠ \hat{φ}ₖ}
    \hat{φ}_{Λ}_{_{D}},ĉ_{Λ}_{_{D}} ← MUTATELEAVES(φ_{Λ}_{_{D}},s_{Λ}_{_{D}},y_{Λ}_{_{D}},\hat{Ω}_{D}^{focus})
    mₖ^{leaf} ← mₖ^{leaf} + 1 ∀k ∈ Λ_{D} : φₖ ≠ \hat{φ}ₖ
    if Σ_{k∈Λ}_{_{D}} max(cₖ^{native},cₖ^{stop}) < Σ_{k∈Λ}_{_{D}} max(cₖ^{native},cₖ^{stop})
      Ω_{D}^{focus} ← Ω_{D}^{focus} ∪ {k ∈ Λ_{D} : φₖ ≠ \hat{φ}ₖ}
      φ_{Λ}_{_{D}},c_{Λ}_{_{D}} ← \hat{φ}_{Λ}_{_{D}},ĉ_{Λ}_{_{D}}
    Ω_{D}^{leaf} ← {k ∈ Ω_{D}^{focus} : cₖ^{native} > cₖ^{stop}
        and mₖ^{leaf} < M_{leaf}}
  return φ_{Λ}_{_{D}},c_{Λ}_{_{D}}
MUTATELEAVES(φ_{Λ}_{_{D}},s_{Λ}_{_{D}},y_{Λ}_{_{D}},Ω_{D}^{focus})
  c_{Λ}_{_{D}} ← NODALDEFECTS(φ_{Λ}_{_{D}},s_{Λ}_{_{D}},y_{Λ}_{_{D}})
  γ^{mutate} ←
  m_{Λ}_{_{D}}^{mutate} ← 0
  Ω_{D}^{mutate} ← {k ∈ Ω_{D}^{focus} : cₖ^{native} > cₖ^{stop}}
  while Ω_{D}^{mutate} ≠
    ξ,φ_{Λ}_{_{D}} ← WEIGHTEDMUTATIONSAMPLING(φ^{A}_{D},
        {cₖ¹, . . . ,cₖ^{|s}_{^{k}}^{|}∀k ∈ Ω_{D}^{mutate}})
    if ξ ∈ γ^{mutate}
      mₖ^{mutate} ← mₖ^{mutate} + 1 ∀k ∈ Λ_{D} : φₖ ≠ \hat{φ}ₖ
    else
      ĉ_{Λ}_{_{D}} ← NODALDEFECTS(\hat{φ}_{Λ}_{_{D}},s_{Λ}_{_{D}},y_{Λ}_{_{D}})
      if Σ_{k∈ Λ}_{_{D}} max(cₖ^{native},cₖ^{stop}) < Σ_{k∈Λ}_{_{D}} max(cₖ^{native},cₖ^{stop})
        Ω_{D}^{focus} ← Ω_{D}^{focus} ∪ {k ∈ Λ_{D} : φₖ ≠ \hat{φ}ₖ}
        mₖ^{mutate} ← 0 ∀k ∈ Λ_{D} : φₖ ≠ \hat{φ}ₖ
        γ^{mutate} ←
        φ_{Λ}_{_{D}},c_{Λ}_{_{D}} ← \hat{φ}_{Λ}_{_{D}},ĉ_{Λ}_{_{D}}
} else
        mₖ^{mutate} ← mₖ^{mutate} + 1 ∀k ∈ Λ_{D} : φₖ ≠ \hat{φ}ₖ
        γ^{mutate} ← γ^{mutate} ∪ ξ
    Ω_{D}^{mutate} ← {k ∈ Ω_{D}^{focus} : cₖ^{native} > fₛₜₒₚ|sₖ^{native}|yₖ
        and mₖ^{mutate} < Mₘᵤₜₐₜₑ|sₖ| }
  return φ_{Λ}_{_{D}},c_{Λ}_{_{D}}
NODALDEFECTS(φ_{Λ}_{_{d}},s_{Λ}_{_{d}},y_{Λ}_{_{d}})
  Q_{Λ}_{_{d}},P_{Λ}_{_{d}} ← NODALPROPERTIES(φ_{Λ}_{_{d}})
  Q_{Ψ}_{_{active}} ← COMPLEXPFUNC(Q_{Λ}_{_{d}},P_{Λ}_{_{d}},s_{Λ}_{_{d}})
  x_{Ψ0}⁰ = A_{Ψ0},jyj ∀j ∈ Ψ_{active}
  if Ψₚₐₛₛᵢᵥₑ ≠
  x_{Ψ0}⁰ = x_{Ψ0}⁰ (1 − fₛₜₒₚfₚₐₛₛᵢᵥₑ)
    \hat{x}_{Ψ}_{_{active}} ← COMPLEXCONCENTRATIONS(Q_{Ψ}_{_{active}},x_{Ψ0}⁰)
  x_{Λ}_{_{d}} ← NODALCONCENTRATIONS(\hat{x}_{Ψ}_{_{active}})
  n_{Λ}_{_{d}} ← NODALCOMPLEXDEFECT(P_{Λ}_{_{d}})
  c_{Λ}_{_{d}} ← NODALTESTTUBEDEFECT(n_{Λ}_{_{d}},x_{Ψ}_{_{d}},y_{Λ}_{_{d}})
  return c_{Λ}_{_{d}}
```

What is claimed is:

1. A method of designing the sequence of nucleic acid molecules that will form a predetermined secondary structure in solution, comprising:
providing a set of desired on-target nucleic acid complexes each having a target secondary structure and a target concentration;
providing a set of undesired off-target nucleic acid complexes each having a vanishing target concentration; and
designing the sequence of one or more nucleic acid molecules that will predominantly form the on-target secondary structures at approximately the on-target concentrations, and will predominantly not form the undesired off-target complexes.

2. The method of claim 1, wherein designing the sequence comprises calculating a test tube ensemble defect corresponding to the concentration of incorrectly paired nucleotides in a candidate sequence at equilibrium evaluated over the ensemble of a theoretical test tube containing the nucleic acid molecules.

3. The method of claim 2, wherein the test tube ensemble defect is calculated for a target test tube with target secondary structures, s_{Ψ}, target concentrations, y_{Ψ}, and candidate sequences, φ_{Ψ}, the test tube ensemble defect being:
$$C ( {φ}_{Ψ} , {s}_{Ψ} , {y}_{Ψ} ) = {\sum }_{j ∈ Ψ} c ( {φ}_{j} , {s}_{j} , {y}_{j} )$$
and is expressed in terms of the defect contribution of each complex jεΨ as:
$$c ( {φ}_{j} , {s}_{j} , {y}_{j} ) = n ( {φ}_{j} , {s}_{j} ) min ( {x}_{j} , {y}_{j} ) + \vert {s}_{j} \vert max ( {y}_{j} - {x}_{j} , 0 ) .$$

4. The method of claim 2, wherein the test tube ensemble defect for a target test tube with target secondary structures, s_{Ψ}, and target concentrations, y_{Ψ}, seeks to design a set of sequences, φ_{Ψ}, such that the test tube ensemble defect satisfies the test tube stop condition:
C(φ_{Ψ},s_{Ψ},y_{Ψ})≦Cₛₜₒₚ (6)
with
Cₛₜₒₚ≡fₛₜₒₚyₙₜ (7)
for a user-specified value of fₛₜₒₚε(0,1).

5. The method of claim 1, wherein designing the sequence of one or more nucleic acid molecules comprises decomposing each on-target complex into a tree of substructures containing a root node and leaf nodes.

6. The method of claim 4, wherein physical quantities calculated at each leaf node are used to estimate a test tube ensemble defect contribution of the root node.

7. The method of claim 1, wherein designing the sequence of one or more nucleic acid molecules comprises decomposing each off-target complex into a tree of substructures having a root node and leaf nodes using equilibrium base-pairing probability matrices to decompose the off-target complexes for which no target structure was provided.

8. The method of claim 1, further comprising specifying complementarity constraints as part of the design specification so that the same sequence domain, or its complement, can required to appear in multiple target complexes.

9. The method of claim 1, wherein the target concentration is the target concentration of an RNA molecule in a dilute solution.

10. The method of claim 1, wherein the vanishing target concentration is a concentration of zero in a dilute solution.

11. The method of claim 1, wherein designing the sequence of one or more nucleic acid molecules that will predominantly form the on-target secondary structures at approximately the on-target concentrations, and predominantly not form the off-target complexes, comprises designing nucleic acid sequences that satisfy the test tube stop condition with fₛₜₒₚ between 0.5 and 0.001

12. An electronic system configured to design a sequence of nucleic acid molecules that will form a predetermined secondary structure in solution, comprising:
a first module configured to determine a set of desired on-target nucleic acid complexes each having a target secondary structure and a target concentration;
a second module configured to determine a set of undesired off-target nucleic acid complexes each having a vanishing target concentration;
a processor programmed to design the sequence of one or more nucleic acid molecules that will predominantly form the on-target secondary structures at approximately the on-target concentrations, and will predominantly not form the undesired off-target complexes; and
an output port configured to output the design of the one or more nucleic acid molecules.

13. The electronic system of claim 12, wherein the output port is configured to output the design of the one or more nucleic acid molecules to a computer display.

14. The electronic system of claim 12, wherein the first module and the second module comprise software instructions running on a computer processor.

15. The electronic system of claim 12, wherein the processor is programmed to calculate a test tube ensemble defect corresponding to the concentration of incorrectly paired nucleotides in a candidate sequence at equilibrium evaluated over the ensemble of a theoretical test tube containing the nucleic acid molecules.

16. The electronic system of claim 15, wherein the test tube ensemble defect is calculated for a target test tube with target secondary structures, s_{Ψ}, target concentrations, y_{Ψ}, and candidate sequences, φ_{Ψ}, the test tube ensemble defect being:
$$C ( {φ}_{Ψ} , {s}_{Ψ} , {y}_{Ψ} ) = {\sum }_{j ∈ Ψ} c ( {φ}_{j} , {s}_{j} , {y}_{j} )$$
and is expressed in terms of the defect contribution of each complex jεΨ as:
$$c ( {φ}_{j} , {s}_{j} , {y}_{j} ) = n ( {φ}_{j} , {s}_{j} ) min ( {x}_{j} , {y}_{j} ) + \vert {s}_{j} \vert max ( {y}_{j} - {x}_{j} , 0 ) .$$

17. The electronic system of claim 15, wherein the test tube ensemble defect for a target test tube with target secondary structures, s_{Ψ}, and target concentrations, y_{Ψ}, seeks to design a set of sequences, φ_{Ψ}, such that the test tube ensemble defect satisfies the test tube stop condition:
C(φ_{Ψ},s_{Ψ},y_{Ψ})≦Cₛₜₒₚ (6)
with
Cₛₜₒₚ≡fₛₜₒₚyₙₜ (7)
for a user-specified value of fₛₜₒₚε(0,1).

18. The electronic system of claim 12, wherein the processor is programmed to design the sequence of the one or more nucleic acid molecules by decomposing each on-target complex into a tree of substructures containing a root node and leaf nodes.

19. The electronic system of claim 18, wherein physical quantities calculated at each leaf node are used to estimate a test tube ensemble defect contribution of the root node.

20. A non-transitory computer readable medium comprising instructions that when executed by a processor perform a method comprising:
providing a set of desired on-target nucleic acid complexes each having a target secondary structure and a target concentration;
providing a set of undesired off-target nucleic acid complexes each having a vanishing target concentration; and
designing the sequence of one or more nucleic acid molecules that will predominantly form the on-target secondary structures at approximately the on-target concentrations, and will predominantly not form the undesired off-target complexes.

21. The non-transitory computer readable medium of claim 20, wherein the instructions perform a method of designing the sequence of one or more nucleic acid molecules by calculating a test tube ensemble defect corresponding to the concentration of incorrectly paired nucleotides in a candidate sequence at equilibrium evaluated over the ensemble of a theoretical test tube containing the nucleic acid molecules.
